(19) United States
(12) Patent Application Publication
(10) Pub. No.: US 2026/0111880 A1
(43) Pub. Date: Apr. 23, 2026

(54) METHODS AND ARRANGEMENTS TO COMMUNICATE DATA

(71) Applicant: Capital One Services, LLC, McLean, VA (US)

(72) Inventors: Michael Mossoba, Arlington, VA (US); Bob Uni Koshy, Henrico, VA (US); Matthew Kloster, Falls Church, VA (US)

(73) Assignee: Capital One Services, LLC, McLean, VA (US)

(21) Appl. No.: 18/920,022

(22) Filed: Oct. 18, 2024

(51) Int. Cl. G06Q 20/38; G06Q 20/34

(52) U.S. Cl. CPC G06Q 20/3821; G06Q 20/352; G06Q 20/3829

(57) ABSTRACT

The disclosed systems and techniques discussed herein include a client device that offers a service to a customer in exchange for approval by customer to transfer customer data to a merchant system. The client device initiates a session with a merchant system to receive the customer data from a bank system and requests approval from the customer to transfer the customer data. By presenting a contactless card to the client device, the contactless card passes a message to the client device and the client device communicates the message with the bank system to validate the contactless card. After validation of the contactless card, the bank system communicates the customer data to the merchant system via a switchboard network to establish the service for the customer.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless card.

### BRIEF SUMMARY

In one aspect, a method, includes receiving, by a server, a request to establish a session to validate a contactless card and perform a function to transfer customer data associated with the contactless card to a merchant server via a switchboard network node, where the request includes a message from the contactless card, session information from the switchboard network node, and a secure session token, verifying the secure session token, validating the message, after validating the message, accessing a record associated with the contactless card in an account database to obtain the customer data, and sending the customer data and an indication that the contactless card is validated to the switchboard network node.

In one aspect, a computing apparatus includes a processor. The computing apparatus also includes a memory storing instructions that, when executed by the processor, configure the processor to receive, from a switchboard network node, a request to establish a session to validate a contactless card and perform a function to transfer customer data associated with the contactless card to a merchant server via the switchboard network node, where the request includes a message from the contactless card, session information from the switchboard network node, and a secure session token, determine if the secure session token is verified the with a node key associated with the switchboard network node, after verifying the secure session token, validate the message, access a record associated with the contactless card in an account database to obtain the customer data, and transmit, to the switchboard network node, the customer data and an indication that the contactless card is validated.

In one aspect, a system includes a processor. The system also includes a memory storing instructions that, when executed by the processor, configure the processor to receive, from a client device, a request for a switchboard session, where the request includes a request for validation of a contactless card and a request for customer data, identify a bank server associated with the contactless card, send, to the bank server, a request to establish a session to validate the contactless card and perform a function to transfer the customer data associated with the contactless card to a merchant server via the switchboard network node, where the request includes a message from the contactless card, session information from the switchboard network node, and a secure session token, send, to the bank server, a node public key, receive the customer data and an indication that the contactless card is validated from the bank server, and send the customer data to the merchant server.

### BRIEF DESCRIPTION OF THE SEVERAL VIEWS OF THE DRAWINGS

FIG. 1 illustrates a system in accordance with one embodiment.

FIG. 2 illustrates an embodiment of communication between a customer, a computing device, and a contactless card in accordance with one embodiment.

FIG. 3 illustrates a first process in accordance with one embodiment.

FIG. 4 illustrates a second process in accordance with one embodiment.

FIG. 5 illustrates a third process in accordance with one embodiment.

FIG. 6 illustrates another embodiment of a system in accordance with one embodiment.

FIG. 7 illustrates another embodiment of a system in accordance with one embodiment.

FIG. 8 illustrates a contactless card 602 in accordance with one embodiment.

FIG. 9 illustrates a transaction card component 900 in accordance with one embodiment.

FIG. 10 illustrates a sequence flow 1000 in accordance with one embodiment.

FIG. 11 is a diagram of a key system according to an example embodiment.

FIG. 12 illustrates an example of a system 1200 configured to operate in accordance with embodiments discussed herein.

FIG. 13 illustrates a process of establishing communication between a client device and a switchboard network node via a DNS server in accordance with one embodiment.

FIG. 14A illustrates a process for establishing a session by a client device with a switchboard network node in accordance with one embodiment.

FIG. 14B illustrates another process for obtaining customer data by a switchboard network node from a bank server (or validator) in accordance with one embodiment.

FIG. 14C illustrates a process for providing the customer data to a client server (merchant server) in accordance with one embodiment.

FIG. 15 illustrates a message generated by a contactless card in accordance with one embodiment.

FIG. 16 illustrates another process in accordance with one embodiment.

FIG. 17 illustrates another system in accordance with one embodiment.

FIG. 18 illustrates another process to validate a contactless card in accordance with one embodiment.

FIG. 19 illustrates an embodiment of a client device (computing device) in accordance with one embodiment.

### DETAILED DESCRIPTION

Embodiments may securely and conveniently exchange customer data for a service via a bank system (or validator) and a merchant system (or client system) based on a customer's authorization to exchange the customer data for the service. For instance, a merchant may offer to email a receipt, sign a customer up for a loyalty program, or provide a discount to a customer in exchange for the customer's email address, phone number, physical address, a combination thereof, or the like. The customer may be interested if there is a convenient, secure, and fast way to provide the customer data to the merchant because, e.g., there is a line of other customers waiting to request services or purchase goods from the merchant. Embodiments described herein offer a solution that is secure, fast, and convenient without significant time or effort by the customer, without typing the information on an awkward user interface, and without vocalizing the customer data for the rest of the customers to possibly overhear.

In some embodiments, a client device such as a merchant computer, the customer's device, a point-of-sale (POS) device, or a merchant device proximate to the POS device may exchange the customer data between the bank server and the merchant server for the customer and the merchant in response to a tap of the customer's contactless card to the client device. Such an arrangement advantageously avoids transfer of data at the local merchant location in some embodiments. In such embodiments, the client device may read or otherwise wirelessly communicate with the contactless card to obtain a message from the card and as an affirmation from the customer that the customer authorizes the transfer of the customer data to a merchant system. In some embodiments, the client device may present a user interface to the customer indicating, generically, the customer data requested for the exchange and ask the customer to bring the contactless card proximate to the client device. In some embodiments, the user interface of the client device may also present terms of service (TOS) to the customer for approval along with the generic indication of the customer data requested for the service. By bringing the contactless card close to the client device, the customer can quickly, securely, and conveniently allow a bank system to transfer to the customer data to the merchant system. In other embodiments, the approval of the terms of service may comprise a separate transaction from the authorization by the customer for the transfer of the customer data.

In some embodiments, the client device may initiate a session with the merchant system to receive the customer data from the bank system and request approval from the customer to transfer the customer data. By presenting a contactless card to a client device, the contactless card passes a message to the client device and the client device communicates the message with the bank system to validate the contactless card via a switchboard network along with an indication of a function to transfer the requested customer data from the bank system to the merchant system. After validation of the contactless card, the bank system communicates the customer data to the merchant system via the switchboard network to establish the service for the customer.

In some embodiments, the merchant may request the customer data from the bank system via the switchboard network without providing the bank system the identity of the merchant (e.g., a merchant identifier (ID)). In some embodiments, the bank system may provide the customer data to the merchant system without providing the identity of the bank system (e.g., issuer ID) to the merchant system. In such embodiments, the switchboard network may receive the merchant ID and the issuer ID but may not communicate the merchant ID to the bank system and/or may not provide the issuer ID to the merchant system. In some embodiments, the switchboard network may obfuscate the identity of the merchant and/or the identity of the bank system and communicate the obfuscated identity in lieu of the identity of the merchant system and/or the bank system. In some embodiments, if the switchboard network does not provide the merchant ID to the bank system or does not provide the issuer ID to the merchant system or obfuscates one of the identities, the process is referred to as single blinding. In some embodiments, if the switchboard network does not provide the merchant ID to the bank system and does not provide the issuer ID to the merchant system, or obfuscates the identities, the process is referred to as double-blinding.

In some embodiments, the bank system may maintain one or more alias email addresses for the email address of the customer and provide an alias email address to the merchant system for the customer so that the customer does not provide the customer's actual email address to the merchant system. In such embodiments, the alias email address may be associated with an email forwarding service such that the customer may receive emails from the merchant system even though the merchant system does not have the customer's actual email address.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

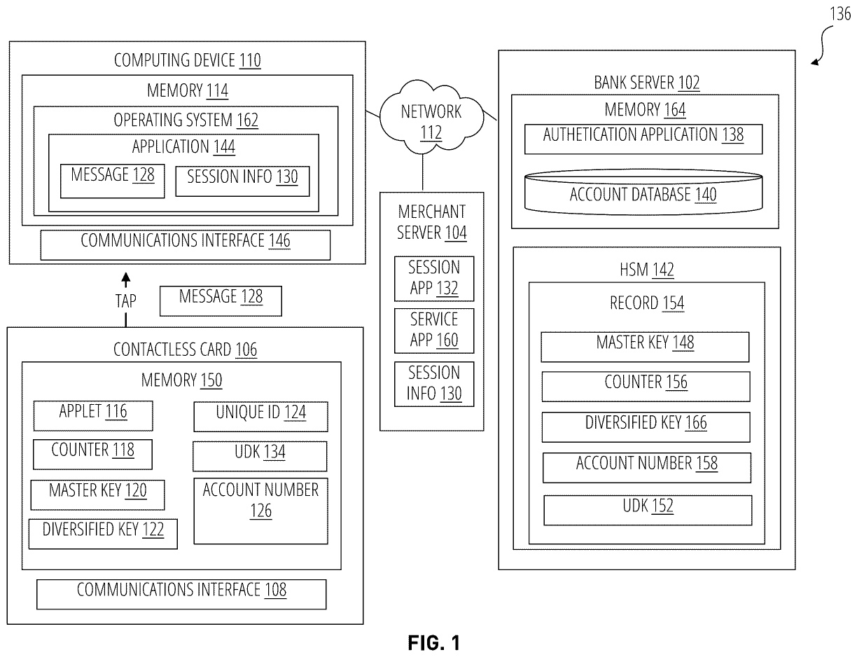

FIG. 1A depicts an exemplary computing architecture 136, also referred to as a system, consistent with disclosed embodiments. Although the computing architecture 136 shown in FIG. 1 has a limited number of elements in a certain topology, it may be appreciated that the computing architecture 136 may include more or less elements in alternate topologies as desired for a given implementation.

The computing architecture 136 comprises at least one computing device 110, at least one bank server 102, at least one merchant server 104, and at least one contactless card 106. The contactless card 106 is representative of any type of card, such as a credit card, debit card, Automated Teller Machine (ATM) card, gift card, payment card, smart card, and the like. The contactless card 106 may comprise at least one communications interface 108, such as a radio frequency identification (RFID) chip, configured to communicate with a communications interface 108 (also referred to herein as a “card reader”, a “wireless card reader”, and/or a “wireless communications interface”) of the computing devices 110 via near-field communication (NFC), the Europay, Mastercard, and Visa (EMV) standard, or other short-range protocols in wireless communication. Although NFC is used as an example communications protocol herein, the disclosure is equally applicable to other types of wireless communications, such as the EMV standard, Bluetooth®, and/or Wi-Fi®.

The computing device 110 is representative of any number and type of computing devices, such as smartphones, tablet computers, wearable devices, laptops, portable gaming devices, virtualized computing system, merchant terminals, point-of-sale systems, servers, desktop computers, and the like. A mobile device may be used as an example of the computing device 110, but should not be considered limiting of the disclosure.

The bank server 102 is representative of any type of computing device, such as one or more servers, workstations, compute clusters, cloud computing platforms, virtualized computing systems, and/or the like. The merchant server 104 may comprise one or more servers, workstations, compute clusters, cloud computing platforms, virtualized computing systems, and/or the like.

Although not depicted for the sake of clarity, the computing device 110, contactless card 106, bank server 102, and the merchant server 104 each include one or more processor circuits, e.g., to execute programs, code, and/or instructions. The computing device 110, the bank server 102, and the merchant server 104 communicate with each other via a communication network 112, e.g., the Internet and, in some embodiments, a switchboard network.

As shown, a memory 114 of the contactless card 106 includes an applet 116, a counter 118, one or more master keys 120, one or more diversified keys 122, a unique id 124, a primary account number 126, and one or more Unique Derived Keys (UDKs) 162. The unique id 124 may be any identifier that uniquely identifies the contactless card 106 and customer associated with the card. The account number 126 may identify an account associated with the contactless card 106. The applet 116 is executable code configured to perform some or all of the operations described herein. In some instances, the contactless card 106 may include additional applets. For example, in some embodiments, the contactless card 106 may include a payment applet to provide data services, e.g., via EMV, and an authentication applet to perform the authentication operations discussed herein. The computing device 110 may request that a customer provide customer data such as an email address in exchange for a current or future discount, to sign up for a loyalty program, to receive a receipt via email, and/or some other merchant service. Rather than entering the customer data at the computing device 110, the computing device 110 may request that the customer data be transferred from a bank server 102 to a merchant server 104 if the customer brings the contactless card 106 in proximity to the computing device 110. A user interface of the computing device 110 may indicate to the customer that the customer can authorize the transfer of the customer data by, e.g., tapping the contactless card 106 to the terminal or otherwise placing the contactless card 106 close enough to the computing device 110 to establish communication between the contactless card 106 and the computing device 110 to pass a message 128 from the contactless card 106 to the computing device 110. In some embodiments, the message 128 is read by the computing device 110 from the contactless card 106 like an RFID tag. In other embodiments, the contactless card 106 may transmit the message 128 to the computing device 110.

Prior to, during, or after instructing the customer to tap the contactless card 106 to the computing device 110, the computing device 110 may communicate via the network 112 with the merchant server 104 to initiate a session to offer a service and receive the customer data from the bank server 102 in exchange for providing the service to the customer. The merchant server 104 may generate a session and session information 130 via the session application 132 for the exchange of the customer data for the service and return the session information 130 to the computing device 110. In some embodiments, the session information 130 may comprise a nonce and a signed session token.

The contactless card 106 may generate the message 128 for the computing device 110 to read or otherwise receive when the contactless card 106 is brought in proximity to the computing device 110 or a wireless interface of the computing device 110. After receipt of the message 128, the computing device 110 may communicate the message 128 to the bank server 102 to authenticate the contactless card 106 and/or the customer.

The counter 118 is a value maintained by the contactless card 106. The counter 118 may include a number that changes each time data is exchanged between the contactless card 106 and another device, such as the bank server 102 (and/or the contactless card 106 and the computing device 110). The counter 118, master keys 120, diversified keys 122, UDKs 134, account number 126, and/or unique id 124 may be used to provide security in the system 136 as described in greater detail below. In some embodiments, the contactless card 106 may not include the master keys 120. In such embodiments, the master keys 120 may be utilized at the time of manufacture to generate card master keys, e.g., UDKs 134, which may be utilized to generate diversified keys 122, e.g., session keys. In some embodiments, diversified keys 122 are generated each time data such as the message 128 is exchanged with another device and are different from each other, i.e., new diversified keys 122 are generated each exchange.

In some instances, the contactless card 106 communications with the bank server 102 may utilize other encryption techniques, such that the contactless card 106 can securely provide data such as the message 128 to the bank server 102 that can be authenticated. For example, system 136 can utilize a Fast Identity Online (FIDO) Alliance standard of encryption to securely communicate data between the devices. The contactless card 106 may be provisioned with a private key of a private/public pair and the bank server 102 may be provisioned with a public key to authenticate encrypted or signed data from the contactless card 106. In these instances, the authentication process can include a challenge and response process. For example, a device, such as computing device 110, can send a challenge to the contactless card 106, which is a unique request for authentication. The contactless card 106 generates a response (the message 128), e.g., encrypted or signed data (challenge data) using the private key. The response is communicated to the bank server 102 via the computing device 110. The bank server 102 receives the response and authenticates it with the public key, i.e., verifies its authenticity.

In embodiments, the computing device 110 includes a number of components and devices. As shown, a memory 138 of the computing device 110 includes an instance of an operating system 162. Example operating systems include the Android®, iOS®, macOS®, Linux®, and Windows® operating systems. As shown, the operating system 162 includes an application 144.

The application 144 may determine when to present a user interface to the customer and present the user interface to the customer to obtain consent to transfer the customer data from the bank server 102 to the merchant server 104. In some embodiments, the user interface may also present terms of service (TOS) to the customer in conjunction with the service being offered in exchange for the customer data. For instance, the computing device 110 may display the TOS on the user interface of the computing device 110 and indicate that tapping the contactless card 106 to the computing device 110 may both accept the TOS and authorize transfer of the customer data in exchange for the service.

In some embodiments, the application 144 of the computing device 110 may include a client application and a client SDK such as a Javascript® SDK with WebNFC®. The client application may present the offer for the service and, in some embodiments, the TOS to the customer via a display of the computing device 110. The client application may also communicate a session request to the merchant server 104 with a function associated with providing the service to the customer. The client SDK may comprise an application program interface (API) to interact with the bank server 102 and the merchant server 104 after the session is generated by the merchant server 104.

The customer may authenticate the contactless card 106 and/or the customer by tapping the contactless card 106 to the computing device 110 (or otherwise bring the contactless card 106 within communications range of the communications interface 146 of the computing device 110). The client SDK may receive the message 128 in the form of encrypted data such as a cryptogram, from the applet 116 of the contactless card 106. The message 128 may be generated based on any suitable cryptographic technique, e.g., FIDO standard, any other method described herein, and/or the like. In some embodiments, the message 128 may be based on the unique id 124 and/or shared secret of the contactless card 106. In some embodiments, the applet 116 may generate the message 128 and an unencrypted identifier (e.g., the counter 118, the account number 126, the unique ID 124, and/or any other unique identifier) as part of the message 128 communicated to the computing device 110. In at least one embodiment, the message 128 comprises an NFC Data Exchange Format (NDEF) file.

The computing device 110 may receive the message 128 and authenticate it. For example, the client SDK of the application 144 of the computing device 110 may send the message 128 to the bank server 102 for authentication. In some embodiments, the client SDK may include with the message 128 additional verification data, such as information that indicates an identity of the customer. The additional verification data may include an alphanumeric string, a hash key, or any other unique identifier indicative of the customer's identity. In some embodiments, the additional verification data is based on biographical information, such as, name, age, location, birthdate, etc., of the customer. Alternatively, or in addition, the additional verification data may include the customer's account information, such as username, password, etc. The additional verification data may be stored by the client SDK on the computing device 110, in some embodiments.

As stated, the computing architecture 136 can be configured to implement key diversification to secure data, which may be referred to as a key diversification technique herein. Generally, the bank server 102 (or another computing device) and the contactless card 106 may be provisioned with the same master key 120, 148 and/or card master keys (UDKs 162, 148). More specifically, each contactless card 106 is programmed with a distinct master key that has a corresponding pair in the hardware security module (HSM) 142 of the bank server 102. For example, when a contactless card 106 is manufactured, one or more diversified key 122 may be generated from one or more unique master keys 120, e.g., issuer master keys and may be programmed into the memory 150 of the contactless card 106. Similarly, the unique master key 148 may be used to generate corresponding card master keys, UDK 152, stored in a record 154 in the HSM 142.

Furthermore, the diversified keys 122 may be diversified from the UDKs 134 via key generation techniques that takes, as input, a diversification factor, such as the counter 118 and counter 156. In some embodiments, the diversification factor may be the unique id 124 and account number 126 of the contactless card 106. The UDKs 134 and 152 may be stored in the contactless card 106 and bank server 102, respectively. The UDKs 134 may be kept secret from all parties other than the contactless card 106 and bank server 102, thereby enhancing the security of the system 136. Although depicted as being stored in the record 154, in some embodiments, the counter 156 and/or account number 158 are not stored in the HSM 142. For example, the unique id 124, counter 156, and account number 158 may be stored in the account database 140.

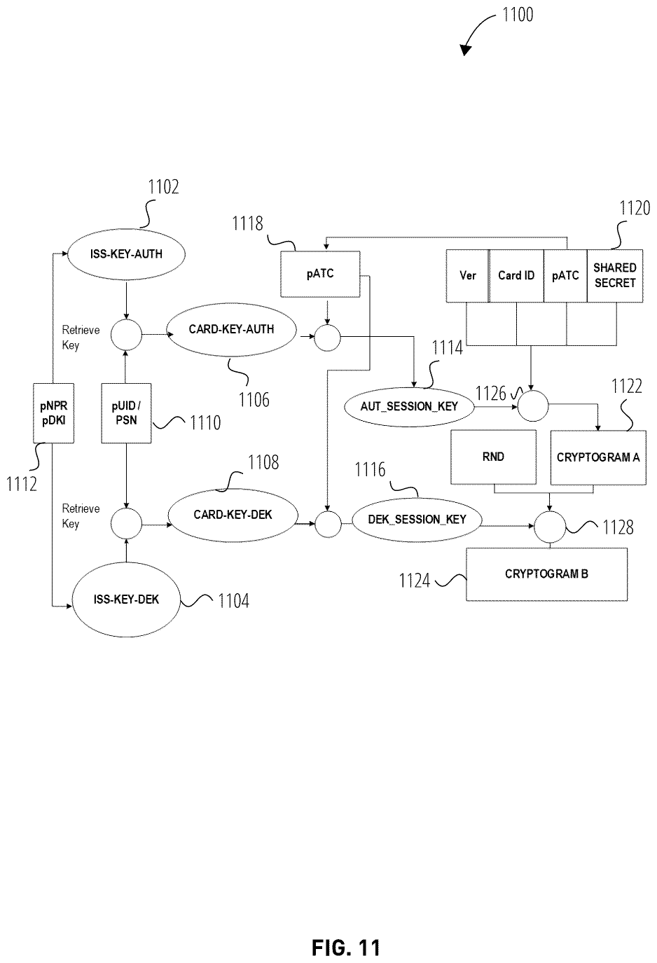

In some embodiments, to generate the message 128, the applet 116 may provide the UDK 162, unique ID 124, and a diversification factor as input to a cryptographic algorithm, thereby producing a diversified keys 122, e.g., session keys. In some embodiments, the diversification factor is the counter 118. In other embodiments, the account number 126 is the diversification factor. The diversified key 122 may then be used to encrypt data, such as the diversification factor (e.g., the counter 118 and/or the account number 126) or other sensitive data (a version number, a card identifier, a shared secret, etc., see, e.g., FIG. 11). The applet 116 and the bank server 102 may be configured to encrypt the same type of data to facilitate the decryption and/or verification processing of a message 128.

As stated, the UDKs 134 and 152 of the contactless card 106 and bank server 102 may be used in conjunction with the counters 118 and 156 to enhance security using key diversification. As stated, the counters 118 and 156 include synchronized values between the contactless card 106 and bank server 102. The counter 118 may include a number that changes each time data is exchanged between the contactless card 106 and the bank server 102 (and/or the contactless card 106 and the computing device 110). When preparing to send data (e.g., to the bank server 102 and/or the device 110), the applet 116 of the contactless card 106 may increment the counter 118. The applet 116 of the contactless card 106 may then provide the UDK 134, unique ID 124, and counter 118 as input to a cryptographic algorithm, which produces a diversified key 122 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES107; a symmetric HMAC algorithm, such as HMAC-SHA-256; and a symmetric CMAC algorithm such as AES-CMAC. In some embodiments, the account number 126 is used as input to the cryptographic algorithm instead of the counter 118 to generate the diversified key 122, e.g., by encrypting the UDK 134, unique id 124 and account number 126.

The applet 116 may then encrypt data using the diversified keys 122 and the data as input to the cryptographic algorithm. For example, encrypting the unique id 124 with the diversified key 122 may result in an encrypted unique id 124 (e.g., the message 128). As stated, the applet 116 and the bank server 102 may be configured to encrypt the same data so the bank server 102 can authenticate the message 128.

In some embodiments, two diversified keys 122 may be generated, e.g., based on one or more portions of the input to the cryptographic function. In some embodiments, the two diversified keys 122 are generated based on two distinct master keys 120, two distinct UDKs 134, the unique id 124, and the counter 118 (or the account number 126). In such embodiments, a message authentication code (MAC) is generated using one of the diversified keys 122, and the MAC may be encrypted using the other one of the diversified keys 122. The MAC may be generated based on any suitable data input to a MAC algorithm, such as sensitive data, the unique id 124, the counter 118, and/or the account number 126. More generally, the applet 116 and the bank server 102 may be configured to generate the MAC based on the same data. In some embodiments, the message 128 is included in a data package such as an NDEF file. The application 144 may then read the data package including message 128 via the communications interface 146 of the computing device 110.

The merchant server 104 may comprise a server associated with the computing device 110 or an application 144 executing on the computing device 110. For instance, the computing device 110 may comprise a merchant point-of-sale device or another device at a merchant location. In other embodiments, the computing device 110 may comprise an application 144 associated with the merchant server 104 such as a shopping application loaded on a computing device 110 of the customer.

The merchant server 104 may comprise a session application 132 and a service application 160. Upon receipt of a request from the computing device 110 to initiate a session to offer a service to the customer, the session application 132 may generate the session and the session information 130. Generating the session may involve storing the session information 130 in memory or other data storage medium of the merchant server 104 to track the session with the customer via the computing device 110. The service app 160 may perform the service for the customer after the customer data is received from the bank server 102. For instance, the service app 160 may email a receipt of a transaction to the customer, sign up the customer for a loyalty program, provide the customer a discount for transaction with the merchant server 104, send coupons or other targeted ads to the customer, and/or the like. In some embodiments, the customer data may include information about the customer's preferences from a customer profile maintained by the bank server 102. In some embodiments, the customer data may include information about the customer's transaction data from a customer profile maintained by the bank server 102 such as types of purchases, periodicity of purchases, products purchased, services purchased, types of products purchased, types of services purchased, and/or the like. Based on the customer data, the merchant server 104 may customize offerings, discounts, ads, and/or the like to provide to the customer via an email service, texting or messaging service, and/or the like.

In some embodiments, the merchant server 104 may receive the customer data from the bank server 102 via a switchboard network of the network 112. In some embodiments, the switchboard network may offer a single-blind or double-blind transaction for passing the customer data from the bank server 102 to the merchant server 104. For instance, the switchboard network may receive a merchant ID from the computing device 110 with the message 128 but may not pass the merchant ID to the bank server 102 for authentication of the contactless card 106 and/or the customer. Similarly, the switchboard network may receive an issuer ID from the bank server 102 with the customer data but the switchboard network may not pass the issuer ID to the merchant server 104 when communicating the customer data to the merchant server 104. In other embodiments, the bank server 102 may receive the merchant ID with the message 128 and the merchant server 104 may receive the issuer ID of the bank server 102 with the customer data.

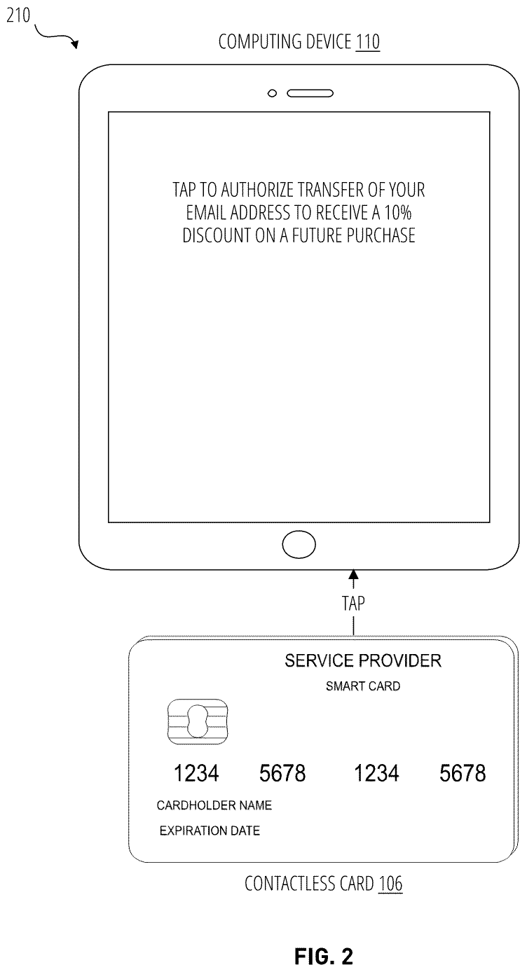

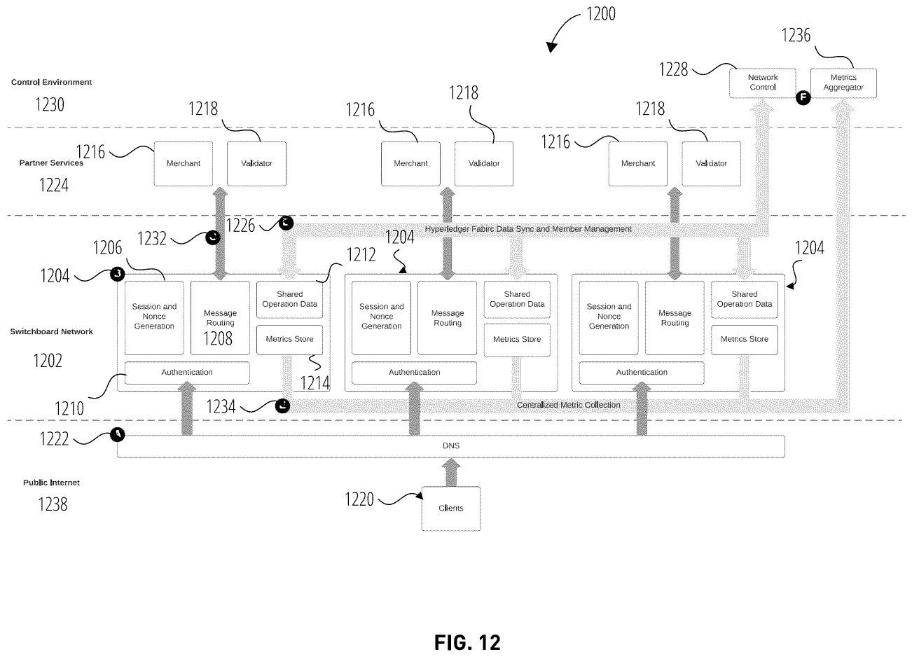

FIG. 2 depicts an embodiment 210 of a request on a display of the computing device 110 for a customer to tap the contactless card 106 to the computing device 110 to authorize the transfer of the customer's email address from the bank server 102 to the merchant server 104 in exchange for a service, which is a ten percent discount on a future transaction. When the customer performs the tap, the contactless card 106 generates the message 128 as encrypted data, signed data, etc. When the contactless card 106 is tapped to the computing device 110, the applet 116 may generate the message 128 in a data package, such as an NDEF file, that is read by the computing device 110. The computing device 110 may then transmit the message 128 to the bank server 102 for verification (e.g., decryption and/or MAC verification) as described herein. FIG. 11 and FIG. 12 illustrate examples of data packet configurations as well as communication of the data packet to the bank server 102 (a validator) via a switchboard network in accordance with embodiments discussed herein.

After the bank server 102 verifies the message 128, the bank server 102 may perform or execute one or more additional functions associated with the request for validation such as a function to gather customer data (such as the email address) and provide the customer data to the merchant server 104 via the network 112. In some embodiments, the bank server 102 may execute the function to gather the customer data from a record in an account database associated with the contactless card 106. After gathering the customer data from the account database, the bank server 102 may transmit the customer data to a switchboard network node of the network 112. The switchboard network node may transmit the customer data to the merchant server 104 along with session information to identify the session with which the customer data is associated. In some embodiments, the bank server 102 may encrypt the customer data with a final key prior to transmitting the customer data to the switchboard network node and may pass an issuer public key to the switchboard network node. The final key may be derived with the issuer public key and the switchboard network node may decrypt the customer data based on the issuer public key or the switchboard network node may pass the issuer public key to the merchant server 104 and the merchant server 104 may decrypt the customer data based on the issuer public key.

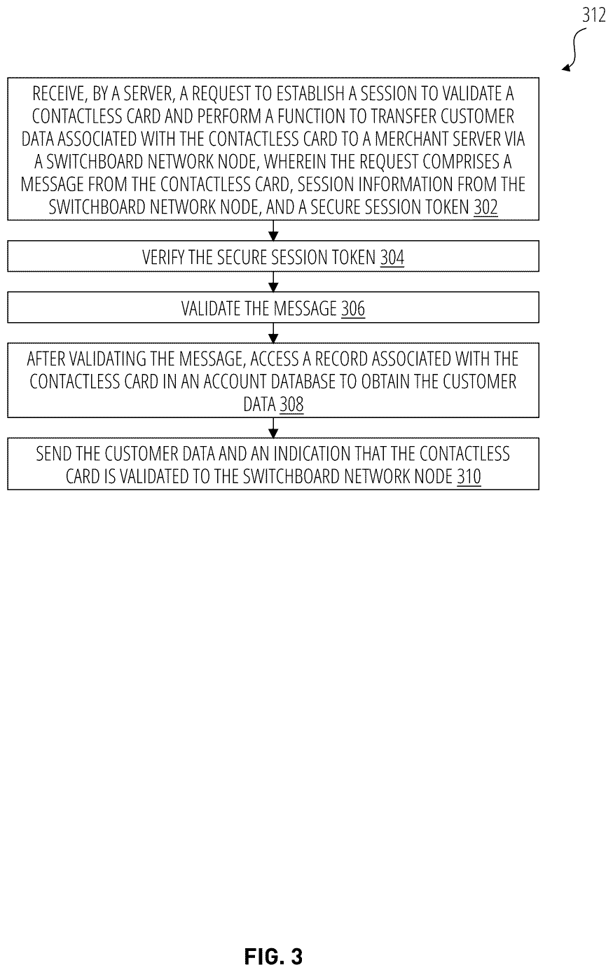

Referring now to FIG. 3, there is shown a process 312 to provide customer data to a switchboard network node after authentication of a contactless card and/or a customer associated with the contactless card to transfer the customer data to a merchant server. At block 302, process 312 receives, by a server such as a bank server or a validator, a request to establish a session to validate a contactless card and perform a function to transfer customer data associated with the contactless card to a merchant server via a switchboard network node. In many embodiments, the request comprises a message from the contactless card, session information from the switchboard network node, and a secure session token. In some embodiments, the request further comprises a client public key, a consent date for a terms of service version. In further embodiments, the request further comprises a client public key. In some embodiments, the request further comprises a consent date for a terms of service version and the terms of service version.

At block 304, process 312 verifies the secure session token. At block 306, process 312 validates the message. In some embodiments, the process 312 further comprises sending an out-of-band request to the switchboard network node to obtain a node public key and verifying the secure session token with the node public key.

At block 308, process 312, after validating the message, accesses a record associated with the contactless card in an account database to obtain the customer data. In some embodiments, the customer data may comprise an email address, a phone number, a physical address, information about preferences associated with a customer profile associated with the contactless card, or a combination thereof. In some embodiments, the customer data comprises a summary of transaction data associated with the contactless card.

At block 310, process 312 sends the customer data and an indication that the contactless card is validated to the switchboard network node. In some embodiments, the process 312 further involves generating an issuer key pair, generating a final key based on an issuer private key of the issuer key pair and the client public key and encrypting the customer data with the final key. In further embodiments, the process 312 may involve sending an issuer public key of the issuer key pair to the switchboard network node.

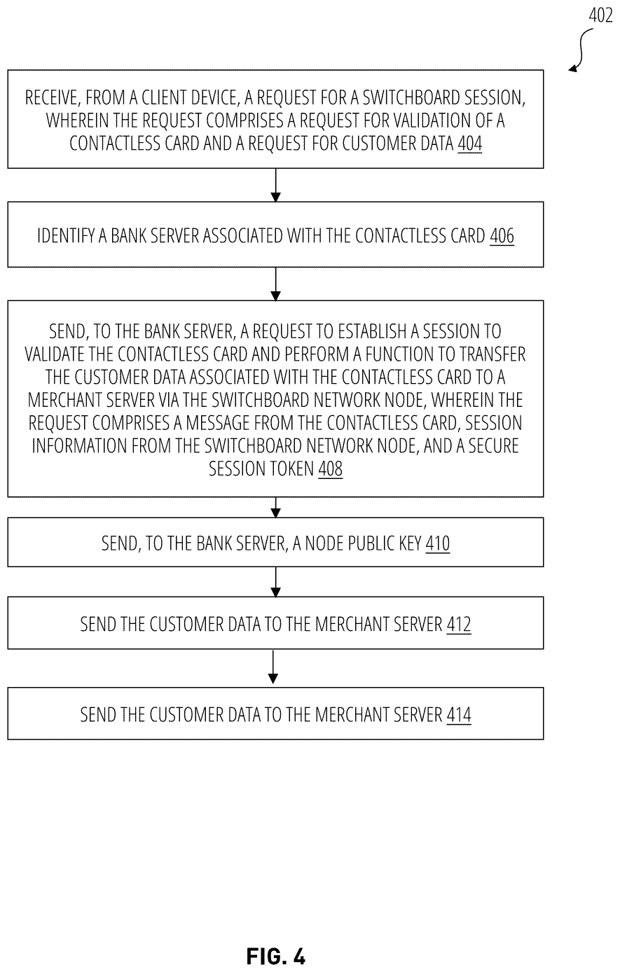

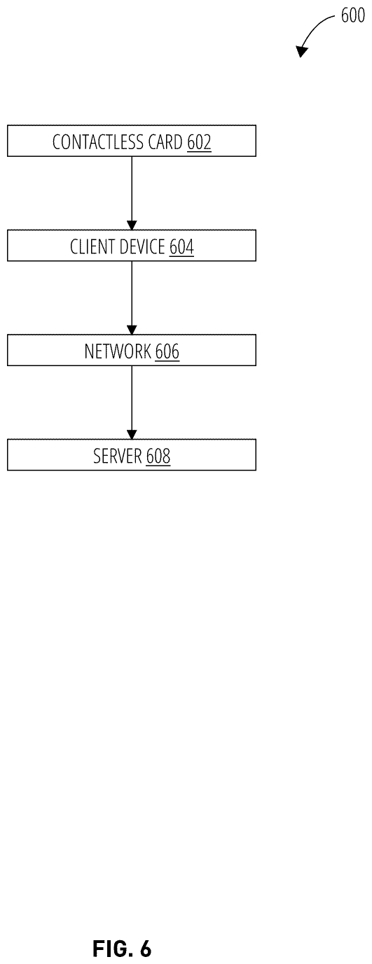

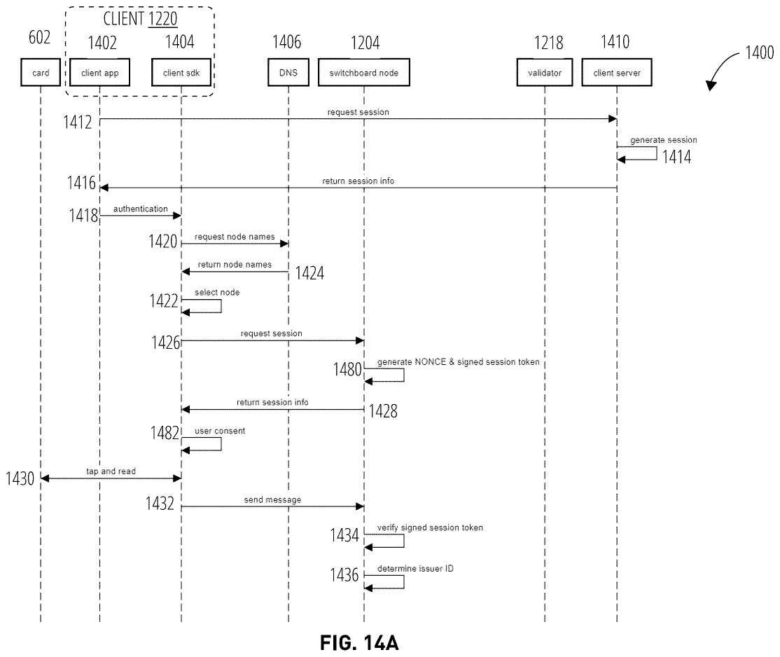

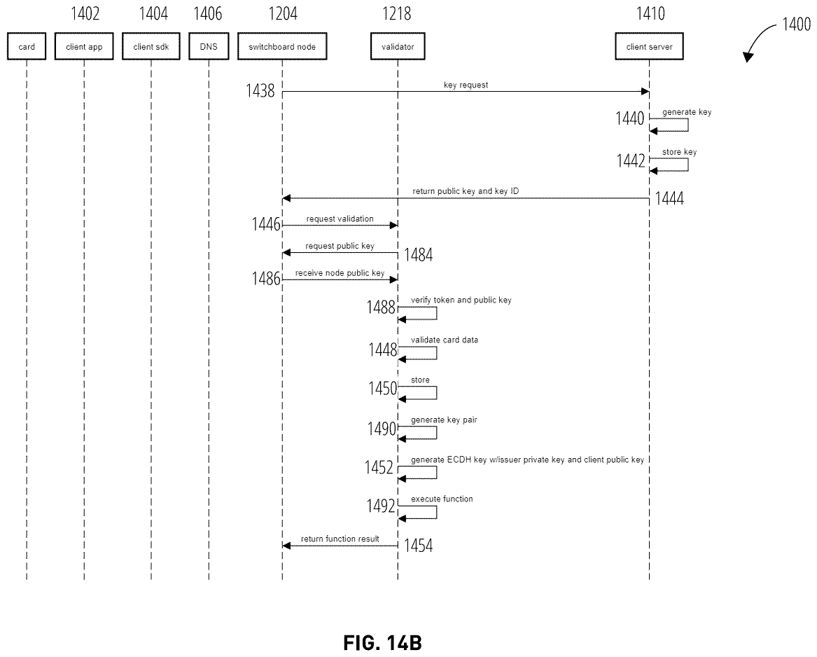

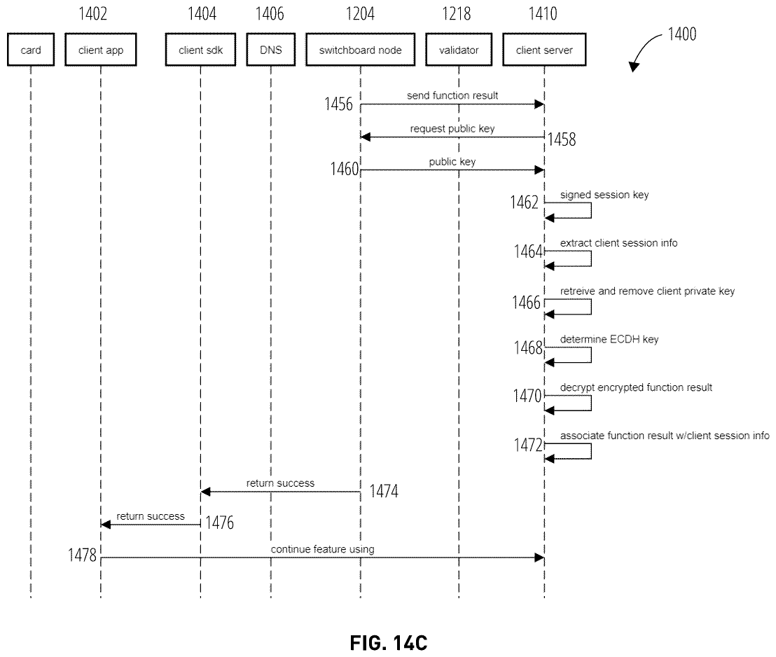

Referring now to FIG. 4, there is shown a process 402 for a switchboard network node to process a request from a client device such as the computing device 110 in FIG. 1 and the client device 604 shown in FIG. 6, and the client 1220 shown in FIG. 14A. At block 404, process 402 receives, from a client device, a request for a switchboard session. The request may comprise a request for validation of a contactless card and a request for customer data. In many embodiments, the request may comprise a message from the contactless card. The message, such as message 128 shown in FIG. 1, may comprise encrypted data that can be validated by a bank server such as the bank server 102 shown in FIG. 1.

In some embodiments, the process 402 may further send a request for a merchant server key to a merchant server such as the merchant 1216 shown in FIG. 12, and receive, in response to the request for the merchant server key, the merchant server key. The request for the merchant server key may associate the merchant server key with a switchboard network session by, e.g., including a session token with the request for the merchant server key.

At block 406, process 402 may identify a bank server associated with the contactless card. For instance, the bank server may comprise a server of a bank that issued the contactless card to the customer such as the validator 1218 shown in FIGS. 14A-14C.

At block 408, process 402 may send, to the bank server, a request to establish a session to validate the contactless card and perform a function to transfer the customer data associated with the contactless card to the merchant server via the switchboard network node. The request may comprise a message from the contactless card, session information from the switchboard network node, and a secure session token.

At block 410, process 402 may send, to the bank server, a node public key. In some embodiments, the process 402 may further receive a request from the bank server for the node public key via an out-of-band communication. In such embodiments, the process 402 may transmit the node public key to the bank server via an out-of-band communication.

At block 412, process 402 may receive the customer data and an indication that the contactless card is validated from the bank server. In some embodiments, the customer data may comprise encrypted data and the switchboard network node may receive an issuer public key from the bank server. In some embodiments, the customer data is encrypted with a final key and the final key may be derived via the issuer public key.

In some embodiments, the customer data comprises an email address, a phone number, a physical address, information about preferences associated with a customer profile associated with the contactless card, or a combination thereof. In further embodiments, the customer data may comprise a summary of transaction data associated with the contactless card.

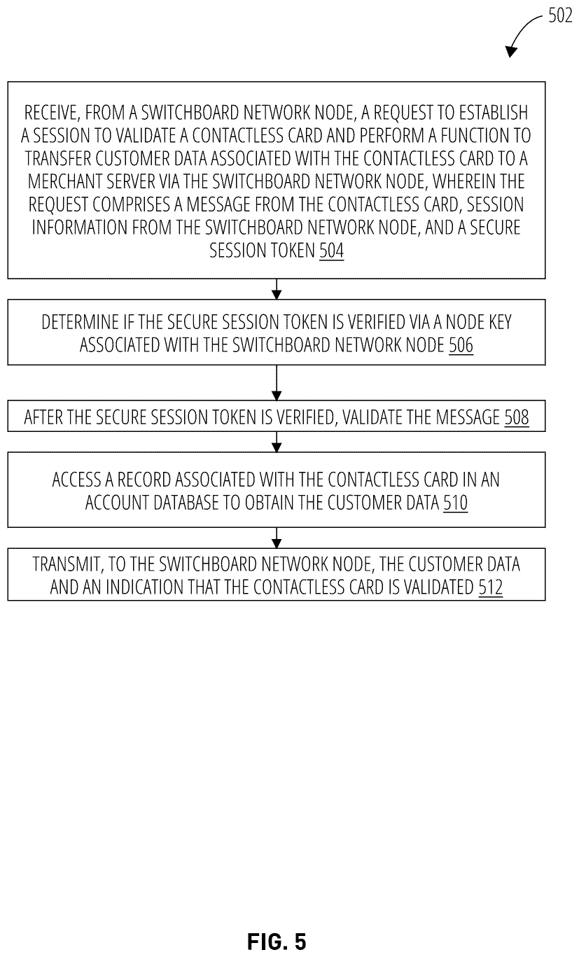

Referring now to FIG. 5, there is shown a process 502 for a bank server to provide customer data to a switchboard network node such as the process shown and discussed in conjunction with FIGS. 14A-14C as well as in other figures herein. At block 504, process 502 may receive, from a switchboard network node, a request to establish a session to validate a contactless card and perform a function to transfer customer data associated with the contactless card to a merchant server via the switchboard network node. The request may comprise a message from the contactless card, session information from the switchboard network node, and a secure session token.

In some embodiments, the process 502 may generate an issuer key pair, generating a final key based on an issuer private key of the issuer key pair and a client public key, wherein the request further comprises the client public key, and encrypting the customer data with the final key. In some embodiments, the generation of the final key involves generation of the final key based on an elliptical curve. In further embodiments, the process 502 may send an issuer public key of the issuer key pair to the switchboard network node.

At block 506, process 5020 determine if the secure session token is verified with a node key associated with the switchboard network node. At block 508, process 502, after verifying the secure session token, may validate the message. At block 510, process 502 may access a record associated with the contactless card in an account database to obtain the customer data.

At block 512, process 502 may transmit the customer data and an indication that the contactless card is validated to the switchboard network node. The customer data may comprise an email address, a phone number, a physical address, information about preferences associated with a customer profile associated with the contactless card, or a combination thereof. In some embodiments, the customer data may comprise a summary of transaction data associated with the contactless card.

FIG. 6 illustrates a data transmission system 600 according to an example embodiment. As further discussed below, system 600 may include contactless card 602, client device 604, network 606, and server 608. Although FIG. 6 illustrates single instances of the components, system 600 may include any number of components.

System 600 may include one or more contactless cards 602, which are further explained below. In some embodiments, contactless card 602 may be in wireless communication, utilizing NFC in an example, with client device 604.

System 600 may include client device 604, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 604 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 604 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 604 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 604 of system 600 may execute one or more applications, such as software applications, that enable, for example, network communications with one or more components of system 600 and transmit and/or receive data.

The client device 604 may be in communication with one or more server(s) 608 via one or more network(s) 606, and may operate as a respective front-end to back-end pair with server 608. The client device 604 may transmit, for example from a mobile device application executing on client device 604, one or more requests to server 608. The one or more requests may be associated with retrieving data from server 608. The server 608 may receive the one or more requests from client device 604. Based on the one or more requests from client device 604, server 608 may be configured to retrieve the requested data from one or more databases (not shown). Based on receipt of the requested data from the one or more databases, server 608 may be configured to transmit the received data to client device 604, the received data being responsive to one or more requests.

System 600 may include one or more networks 606. In some examples, network 606 may be one or more of a wireless network, a wired network or any combination of wireless network and wired network, and may be configured to connect client device 604 to server 608. For example, network 606 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 606 may include, without limitation, telephone lines, fiber optics, IEEE Ethernet 802.3, a wide area network, a wireless personal area network, a LAN, or a global network such as the Internet. In addition, network 606 may support an Internet network, a wireless communication network, a cellular network, or the like, or any combination thereof. network 606 may further include one network, or any number of the exemplary types of networks mentioned above, operating as a stand-alone network or in cooperation with each other. network 606 may utilize one or more protocols of one or more network elements to which they are communicatively coupled. network 606 may translate to or from other protocols to one or more protocols of network devices. Although network 606 is depicted as a single network, it should be appreciated that according to one or more examples, network 606 may comprise a plurality of interconnected networks, such as, for example, the Internet, a service provider's network, a cable television network, corporate networks, such as credit card association networks, and home networks.

System 600 may include one or more servers 608. In some examples, server 608 may include one or more processors, which are coupled to memory. The server 608 may be configured as a central system, server or platform to control and call various data at different times to execute a plurality of workflow actions. Server 608 may be configured to connect to the one or more databases. The server 608 may be connected to at least one client device 604.

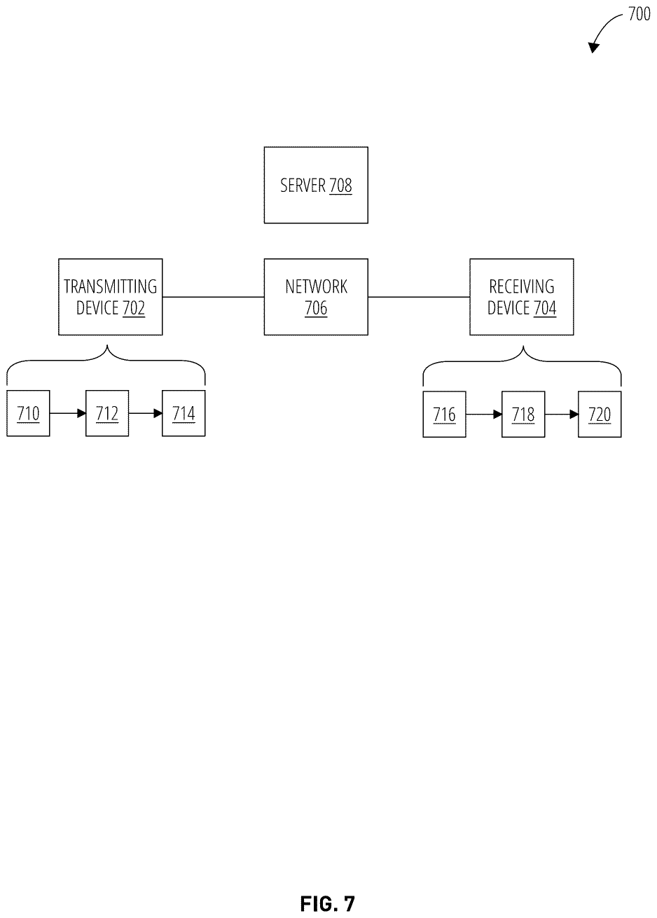

FIG. 7 illustrates a data transmission system according to an example embodiment. System 700 may include a transmitting or transmitting device 702, a receiving or receiving device 704 in communication, for example via network 706, with one or more servers 708. Transmitting or transmitting device 702 may be the same as, or similar to, client device 110 discussed above with reference to FIG. 1A. Receiving or receiving device 704 may be the same as, or similar to, client device 110 discussed above with reference to FIG. 1A. Network 706 may be similar to network 112 discussed above with reference to FIG. 1A. Server 708 may be similar to server 102 discussed above with reference to FIG. 1A. Although FIG. 7 shows single instances of components of system 700, system 700 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 7, system 700 may be configured to implement key diversification. For example, a sender and recipient may desire to exchange data (e.g., original sensitive data) via respective devices 702 and 704. As explained above, although single instances of transmitting device 702 and receiving device 704 may be included, it is understood that one or more transmitting devices 702 and one or more receiving devices 704 may be involved so long as each party shares the same shared secret symmetric key. In some examples, the transmitting device 702 and receiving device 704 may be provisioned with the same master symmetric key. Further, it is understood that any party or device holding the same secret symmetric key may perform the functions of the transmitting device 702 and similarly any party holding the same secret symmetric key may perform the functions of the receiving device 704. In some examples, the symmetric key may comprise the shared secret symmetric key which is kept secret from all parties other than the transmitting device 702 and the receiving device 704 involved in exchanging the secure data. It is further understood that both the transmitting device 702 and receiving device 704 may be provided with the same master symmetric key, and further that part of the data exchanged between the transmitting device 702 and receiving device 704 comprises at least a portion of data which may be referred to as the counter value. The counter value may comprise a number that changes each time data is exchanged between the transmitting device 702 and the receiving device 704.

System 700 may include one or more networks 706. In some examples, network 706 may be one or more of a wireless network, a wired network or any combination of wireless network and wired network, and may be configured to connect one or more transmitting devices 702 and one or more receiving devices 704 to server 708. For example, network 706 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 706 may include, without limitation, telephone lines, fiber optics, IEEE Ethernet 802.3, a wide area network, a wireless personal area network, a LAN, or a global network such as the Internet. In addition, network 706 may support an Internet network, a wireless communication network, a cellular network, or the like, or any combination thereof. Network 706 may further include one network, or any number of the exemplary types of networks mentioned above, operating as a stand-alone network or in cooperation with each other. Network 706 may utilize one or more protocols of one or more network elements to which they are communicatively coupled. Network 706 may translate to or from other protocols to one or more protocols of network devices. Although network 706 is depicted as a single network, it should be appreciated that according to one or more examples, network 706 may comprise a plurality of interconnected networks, such as, for example, the Internet, a service provider's network, a cable television network, corporate networks, such as credit card association networks, and home networks.

In some examples, one or more transmitting devices 702 and one or more receiving devices 704 may be configured to communicate and transmit and receive data between each other without passing through network 706. For example, communication between the one or more transmitting devices 702 and the one or more receiving devices 704 may occur via at least one of NFC, Bluetooth, RFID, Wi-Fi, and/or the like.

At block 710, when the transmitting device 702 is preparing to process the sensitive data with symmetric cryptographic operation, the sender may update a counter. In addition, the transmitting device 702 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 712, the transmitting device 702 may take the selected cryptographic algorithm, and using the master symmetric key, process the counter value. For example, the sender may select a symmetric encryption algorithm, and use a counter which updates with every conversation between the transmitting device 702 and the receiving device 704. The transmitting device 702 may then encrypt the counter value with the selected symmetric encryption algorithm using the master symmetric key, creating a diversified symmetric key.

In some examples, the counter value may not be encrypted. In these examples, the counter value may be transmitted between the transmitting device 702 and the receiving device 704 at block 712 without encryption.

At block 714, the diversified symmetric key may be used to process the sensitive data before transmitting the result to the receiving device 704. For example, the transmitting device 702 may encrypt the sensitive data using a symmetric encryption algorithm using the diversified symmetric key, with the output comprising the protected encrypted data. The transmitting device 702 may then transmit the protected encrypted data, along with the counter value, to the receiving device 704 for processing.

At block 716, the receiving device 704 may first take the counter value and then perform the same symmetric encryption using the counter value as input to the encryption, and the master symmetric key as the key for the encryption. The output of the encryption may be the same diversified symmetric key value that was created by the sender.

At block 718, the receiving device 704 may then take the protected encrypted data and using a symmetric decryption algorithm along with the diversified symmetric key, decrypt the protected encrypted data.

At block 720, as a result of the decrypting the protected encrypted data, the original sensitive data may be revealed.

The next time sensitive data needs to be sent from the sender to the recipient via respective transmitting device 702 and receiving device 704, a different counter value may be selected producing a different diversified symmetric key. By processing the counter value with the master symmetric key and same symmetric cryptographic algorithm, both the transmitting device 702 and receiving device 704 may independently produce the same diversified symmetric key. This diversified symmetric key, not the master symmetric key, is used to protect the sensitive data.

As explained above, both the transmitting device 702 and receiving device 704 each initially possess the shared master symmetric key. The shared master symmetric key is not used to encrypt the original sensitive data. Because the diversified symmetric key is independently created by both the transmitting device 702 and receiving device 704, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 702 and the receiving device 704 may be governed by symmetric requirements for how often to create a new diversification value, and therefore a new diversified symmetric key. In an embodiment, a new diversification value and therefore a new diversified symmetric key may be created for every exchange between the transmitting device 702 and receiving device 704.

In some examples, the key diversification value may comprise the counter value. Other non-limiting examples of the key diversification value include: a random nonce generated each time a new diversified key is needed, the random nonce sent from the transmitting device 702 to the receiving device 704; the full value of a counter value sent from the transmitting device 702 and the receiving device 704; a portion of a counter value sent from the transmitting device 702 and the receiving device 704; a counter independently maintained by the transmitting device 702 and the receiving device 704 but not sent between the two devices; a one-time-passcode exchanged between the transmitting device 702 and the receiving device 704; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 702 and the receiving device 704. In effect, this may create a one-time use key, such as a single-use session key.

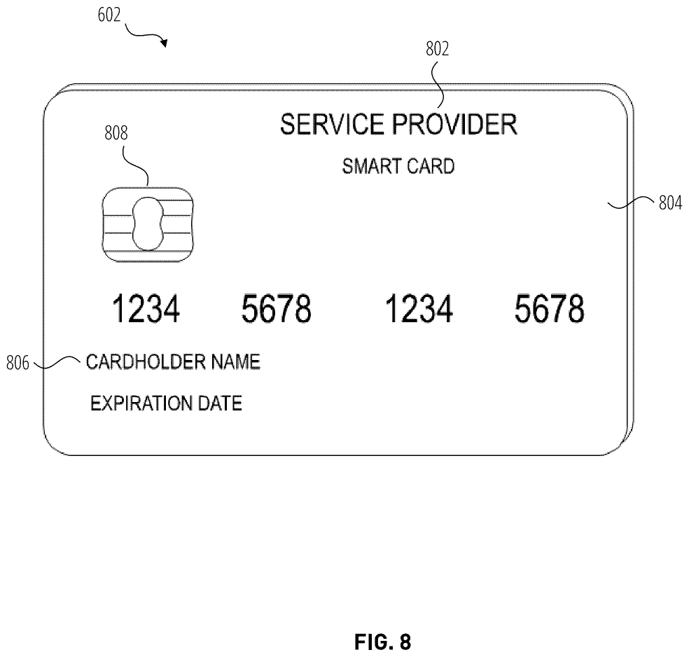

FIG. 8 illustrates an example configuration of a contactless card 602 such as the contactless card 106 in FIG. 1. The contactless card 602 may include a contactless payment card, such as a credit card, debit card, or gift card, issued by a service provider (such as a bank server 102 shown in FIG. 1 or a validator 1218 shown in FIG. 12) as displayed as service provider indicia 802 on the front or back of the contactless card 602. In some examples, the contactless card 602 is not related to a payment card, and may include, without limitation, an identification card or other type of transaction card such as a loyalty card or rewards card. In some examples, the contactless card 602 may include a dual interface contactless payment card, a rewards card, and so forth. The contactless card 602 may include a substrate 804, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 602 may have physical characteristics compliant with the ID-1 format of the ISO/IEC 7816 standard, and the transaction card may otherwise be compliant with the ISO/IEC 14443 standard. However, it is understood that the contactless card 602 according to the present disclosure may have different characteristics, and the present disclosure does not require a transaction card to be implemented in a payment card.

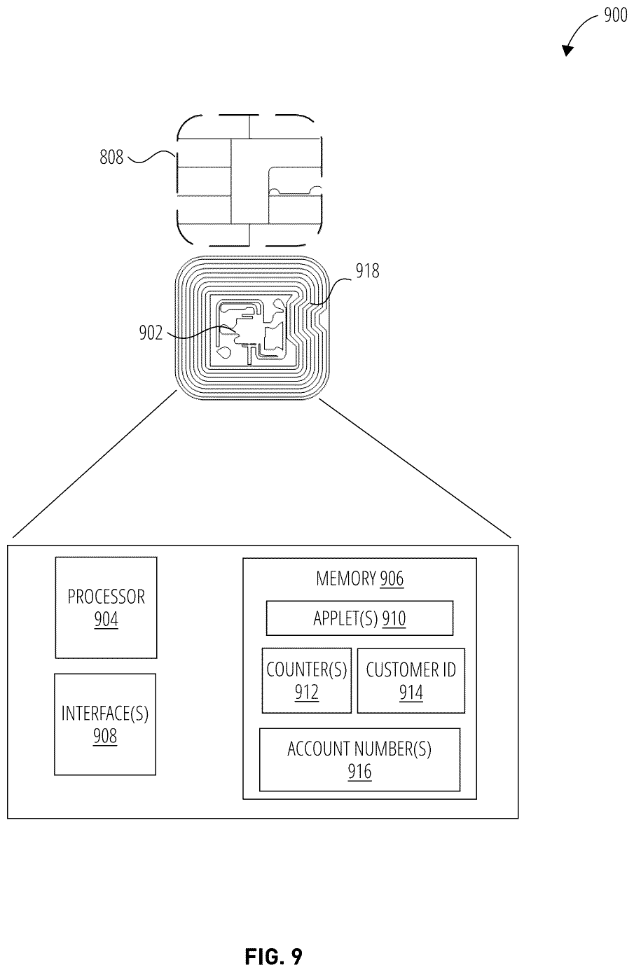

The contactless card 602 may also include identification information 806 displayed on the front and/or back of the card, and a contact pad 808. The contact pad 808 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 602 may also include processing circuitry, antenna and other components as will be further discussed in FIG. 9. These components may be located behind the contact pad 808 or elsewhere on the substrate 804, e.g. within a different layer of the substrate 804, and may electrically and physically coupled with the contact pad 808. The contactless card 602 may also include a magnetic strip or tape, which may be located on the back of the card (not shown in FIG. 8). The contactless card 602 may also include a Near-Field Communication (NFC) device coupled with an antenna capable of communicating via the NFC protocol. Embodiments are not limited in this manner.

As illustrated in FIG. 9, the contact pad 808 of contactless card 602 may include processing circuitry 902 for storing, processing, and communicating information, including a processor 904, a memory 906, and one or more interface(s) 908. It is understood that the processing circuitry 902 may contain additional components, including processors, memories, error and parity/CRC checkers, data encoders, anticollision algorithms, controllers, command decoders, security primitives and tamperproofing hardware, as necessary to perform the functions described herein.

The memory 906 may be a read-only memory, write-once read-multiple memory or read/write memory, e.g., RAM, ROM, and EEPROM, and the contactless card 602 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 906 may be encrypted memory utilizing an encryption algorithm executed by the processor 904 to encrypt data.

The memory 906 may be configured to store one or more applet(s) 910, one or more counter(s) 912, a customer identifier 914, and the account number(s) 916, which may be virtual account numbers. The one or more applet(s) 910 may comprise one or more software applications configured to execute on one or more contactless cards, such as a Java® Card applet. However, it is understood that applet(s) 910 are not limited to Java Card applets, and instead may be any software application operable on contactless cards or other devices having limited memory. The one or more counter(s) 912 may comprise a numeric counter sufficient to store an integer. The customer identifier 914 may comprise a unique alphanumeric identifier assigned to a user of the contactless card 602, and the identifier may distinguish the user of the contactless card from other contactless card users. In some examples, the customer identifier 914 may identify both a customer and an account assigned to that customer and may further identify the contactless card 602 associated with the customer's account. As stated, the account number(s) 916 may include thousands of one-time use virtual account numbers associated with the contactless card 602. An applet(s) 910 of the contactless card 602 may be configured to manage the account number(s) 916 (e.g., to select an account number(s) 916, mark the selected account number(s) 916 as used, and transmit the account number(s) 916 to a mobile device for autofilling by an autofilling service.

The processor 904 and memory elements of the foregoing exemplary embodiments are described with reference to the contact pad 808, but the present disclosure is not limited thereto. It is understood that these elements may be implemented outside of the contact pad 808 or entirely separate from it, or as further elements in addition to processor 904 and memory 906 elements located within the contact pad 808.

In some examples, the contactless card 602 may comprise one or more antenna(s) 918. The one or more antenna(s) 918 may be placed within the contactless card 602 and around the processing circuitry 902 of the contact pad 808. For example, the one or more antenna(s) 918 may be integral with the processing circuitry 902 and the one or more antenna(s) 918 may be used with an external booster coil. As another example, the one or more antenna(s) 918 may be external to the contact pad 808 and the processing circuitry 902.

In an embodiment, the coil of contactless card 602 may act as the secondary of an air core transformer. The terminal may communicate with the contactless card 602 by cutting power or amplitude modulation. The contactless card 106 may infer the data transmitted from the terminal using the gaps in the contactless card's power connection, which may be functionally maintained through one or more capacitors. The contactless card 602 may communicate back by switching a load on the contactless card's coil or load modulation. Load modulation may be detected in the terminal's coil through interference. More generally, using the antenna(s) 918, processor 904, and/or the memory 906, the contactless card 106 provides a communications interface to communicate via NFC, Bluetooth, and/or Wi-Fi communications.

As explained above, contactless card 602 may be built on a software platform operable on smart cards or other devices having limited memory, such as JavaCard, and one or more or more applications or applets may be securely executed. Applet(s) 910 may be added to contactless cards to provide a one-time password (OTP) for multifactor authentication (MFA) in various mobile application-based use cases. Applet(s) 910 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 910 may be configured to encode the OTP as an NDEF type 4 well known type text tag. In some examples, NDEF messages may comprise one or more records. The applet(s) 910 may be configured to add one or more static tag records in addition to the OTP record.

In some examples, the one or more applet(s) 910 may be configured to emulate an RFID tag. The RFID tag may include one or more polymorphic tags. In some examples, each time the tag is read, different cryptographic data is presented that may indicate the authenticity of the contactless card. Based on the one or more applet(s) 910, an NFC read of the tag may be processed, the data may be transmitted to a server, such as a server of a banking system, and the data may be validated at the server.

In some examples, the contactless card 602 and server may include certain data such that the card may be properly identified. The contactless card 602 may include one or more unique identifiers (not pictured). Each time a read operation takes place, the counter(s) 912 may be configured to increment. In some examples, each time data from the contactless card 602 is read (e.g., by a mobile device), the counter(s) 912 is transmitted to the server for validation and determines whether the counter(s) 912 are equal (as part of the validation) to a counter of the server.

The one or more counter(s) 912 may be configured to prevent a replay attack. For example, if a cryptogram has been obtained and replayed, that cryptogram is immediately rejected if the counter(s) 912 has been read or used or otherwise passed over. If the counter(s) 912 has not been used, it may be replayed. In some examples, the counter that is incremented on the card is different from the counter that is incremented for transactions. The contactless card 106 is unable to determine the application transaction counter(s) 912 since there is no communication between applet(s) 910 on the contactless card 602.

In some examples, the counter(s) 912 may get out of sync. In some examples, to account for accidental reads that initiate transactions, such as reading at an angle, the counter(s) 912 may increment but the application does not process the counter(s) 912. In some examples, when the mobile device 10 is woken up, NFC may be enabled and the device 110 may be configured to read available tags, but no action is taken responsive to the reads.

To keep the counter(s) 912 in sync, an application, such as a background application, may be executed that would be configured to detect when the mobile device 110 wakes up and synchronize with the server of a banking system indicating that a read that occurred due to detection to then move the counter forward. In other examples, Hashed One Time Password may be utilized such that a window of mis-synchronization may be accepted. For example, if within a threshold of 10, the counter(s) 912 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 912 increases in the appropriate sequence, then it possible to know that the user has done so.

The key diversification technique described herein with reference to the counter(s) 912, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 602, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 602. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 106 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

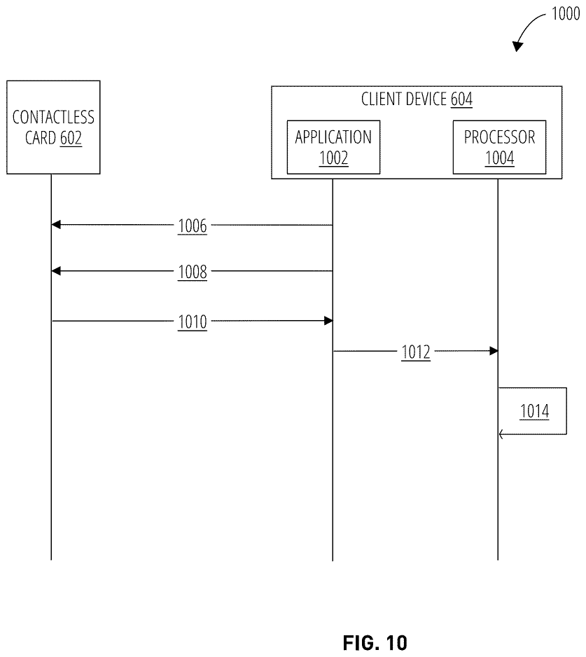

FIG. 10 is a timing diagram illustrating an example sequence for providing authenticated access according to one or more embodiments of the present disclosure. Sequence flow 1000 may include contactless card 602 and client device 604, which may include an application 1002 and processor 1004.

At line 1006, the application 1002 communicates with the contactless card 602 (e.g., after being brought near the contactless card 602). Communication between the application 1002 and the contactless card 602 may involve the contactless card 602 being sufficiently close to a card reader (not shown) of the client device 604 to enable NFC data transfer between the application 1002 and the contactless card 602.

At line 1008, after communication has been established between client device 604 and contactless card 602, contactless card 602 generates a message authentication code (MAC) cryptogram. In some examples, this may occur when the contactless card 602 is read by the application 1002. In particular, this may occur upon a read, such as an NFC read, of a near field data exchange (NDEF) tag, which may be created in accordance with the NFC Data Exchange Format. For example, a reader application, such as application 1002, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 602 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1002 may be configured to transmit a request to contactless card 602, the request comprising an instruction to generate a MAC cryptogram.

At line 1010, the contactless card 602 sends the MAC cryptogram to the application 1002. In some examples, the transmission of the MAC cryptogram occurs via NFC, however, the present disclosure is not limited thereto. In other examples, this communication may occur via Bluetooth, Wi-Fi, or other means of wireless data communication. At line 1012, the application 1002 communicates the MAC cryptogram to the processor 1004.

At line 1014, the processor 1004 verifies the MAC cryptogram pursuant to an instruction from the application 144. For example, the MAC cryptogram may be verified, as explained below. In some examples, verifying the MAC cryptogram may be performed by a device other than client device 604, such as a server of a banking system in data communication with the client device 604. For example, processor 1004 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 11 illustrates a diagram of a system 1100 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1102, 1104 may be required for each part of the portfolio on which the one or more applets is issued. For example, the first master key 1102 may comprise an Issuer Cryptogram Generation/Authentication Key (Iss-Key-Auth) and the second master key 1104 may comprise an Issuer Data Encryption Key (Iss-Key-DEK). As further explained herein, two issuer master keys 1102, 1104 are diversified into card master keys 1106, 1108, which are unique for each card. In some examples, a network profile record ID (pNPR) 522 and derivation key index (pDKI) 1110, as back office data, may be used to identify which Issuer Master Keys 1102, 1104 to use in the cryptographic processes for authentication. The system performing the authentication may be configured to retrieve values of pNPR 1112 and pDKI 1110 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1106 and Card-Key-Dek 1108). The session keys (Aut-Session-Key 1114 and DEK-Session-Key 1116) may be generated by the one or more applets and derived by using the application transaction counter (pATC) 1118 with one or more algorithms. To fit data into the one or more algorithms, only the 2 low order bytes of the 4-byte pATC 1118 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 1118 counter. At each tap of the contactless card, pATC 1118 is configured to be updated, and the card master keys Card-Key-AUTH 508 and Card-Key-DEK 1108 are further diversified into the session keys Aut-Session-Key 1114 and DEK-Session-KEY 1116. pATC 1118 may be initialized to zero at personalization or applet initialization time. In some examples, the pATC counter 1118 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1114. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1114, as explained above. As explained above, the low order two bytes of the counter may be used to diversify for the one or more MAC session keys. As explained below, AUT-Session-Key 1114 may be used to MAC data 1120, and the resulting data or cryptogram A 1122 and random number RND may be encrypted using DEK-Session-Key 1116 to create cryptogram B or output 1124 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1116 derived from the Card-Key-DEK 1108. In this case, the ATC value for the session key derivation is the least significant byte of the counter pATC 1118.

The Table 1 below is a format that represents a binary version example embodiment. Further, in some examples, the first byte may be set to ASCII ‘A’.

Message Format

| 1 | 2 | 4 | 8 | 8 |
|---|---|---|---|---|
| 0x43 (Message Type | Version | pATC | RND | Cryptogram A |
| ‘A’) | | | | (MAC) |

Cryptogram A (MAC) 8 bytes
MAC of

| 2 | 8 | 4 | 4 | 18 bytes input data |
|---|---|---|---|---|
| Version | pUID | pATC | Shared | |
| | | | Secret | |

Message Format

| 1 | 2 | 4 | 16 |
|---|---|---|---|
| 0x43 (Message Type | Version | pATC | Cryptogram B |
| ‘A’) | | | |

Cryptogram A (MAC) 8 bytes
MAC of

| 2 | 8 | 4 | 4 | 18 bytes input data |
|---|---|---|---|---|
| Version | pUID | pATC | Shared | |
| | | | Secret | |

Cryptogram B 16
Sym Encryption of

| 8 | 8 |
|---|---|
| RND | Cryptogram A |

The Table 2 below is another exemplary format. In this example, the tag may be encoded in hexadecimal format.

Message Format

| 2 | 8 | 4 | 8 | 8 |
|---|---|---|---|---|
| Version | pUID | pATC | RND | Cryptogram A |
| | | | | (MAC) |

8 bytes

| 8 | 8 | 4 | 4 | 18 bytes input data |
|---|---|---|---|---|
| pUID | pUID | pATC | Shared | |
| | | | Secret | |

Message Format

| 2 | 8 | 4 | 16 |
|---|---|---|---|
| Version | pUID | pATC | Cryptogram B |

8 bytes

| 8 | 4 | 4 | 18 bytes input data |
|---|---|---|---|
| pUID | pUID | pATC | Shared |
| | | | Secret |

Cryptogram B 16
Sym Encryption of

| 8 | 8 |
|---|---|
| RND | Cryptogram A |

The UID field of the received message may be extracted to derive, from master keys Iss-Key-AUTH 1102 and Iss-Key-DEK 1104, the card master keys (Card-Key-Auth 1106 and Card-Key-DEK 1108) for that particular card. Using the card master keys (Card-Key-Auth 1108 and Card-Key-DEK 1108), the counter (pATC) field of the received message may be used to derive the session keys (Aut-Session-Key 1114 and DEK-Session-Key 1116) for that particular card. Cryptogram B 1124 may be decrypted using the DEK-Session-KEY, which yields cryptogram An 1122 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram An 1122, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1114. The input data 1120 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1126, data 1120 is processed through the MAC using Aut-Session-Key 1114 to produce MAC output (cryptogram A) 1122, which is encrypted.

In order to provide additional protection against brute force attacks exposing the keys on the card, it is desirable that the MAC cryptogram 1122 be enciphered. In some examples, data or cryptogram An 1122 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1116. In the encryption operation 1128, data or cryptogram An 1122 and RND are processed using DEK-Session-Key 510 to produce encrypted data, cryptogram B 1124. The data 1122 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

Referring now to FIG. 12, some embodiments may be implemented in a multi-issuer environment and messages are routed through a switchboard system, such as system 1200. FIG. 12 illustrates an example of system 1200 in accordance with the embodiments discussed herein. The system 1200 includes additional devices and systems configured to enable contactless card issuers to tap-to-card services. Specifically, system 1200 enables any number of issuer systems to provide card services to their clients through a switching fabric, i.e., a switchboard network 1202 in a secure and safe manner.

In embodiments, the switchboard network 1202 includes one or more nodes 1204 configured to perform routing operations. Each switchboard node 1204 may include a session and nonce generator 1206, a message router 1208, an authentication 1210, an operation data 1212 store, and a metrics store 1214. Further, each of the nodes may be configured the same and share configurations, but each switchboard node 1204 may independently process and route messages and requests to the appropriate systems, such as the merchant systems and issuer systems. Each of the nodes 1204 is configured to act as a broker of trust between an issuer system, the merchant system 1216, and/or validation system 1218, for example. Each switchboard node 1204 is configured to route each message to the correct issuer system while maintaining data security. For example, a switchboard node 1204 may route a message between an issuer system and a merchant system while the node cannot access the private data in the message.

The switchboard network 1202 may be configured as a server system with a collection of hardware, software, and networking components that work together to provide client services. Hardware components may include one or more server computers, storage devices, and network adapters. The server computers are configured to run server applications, such as those executable on each of the nodes 1204. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

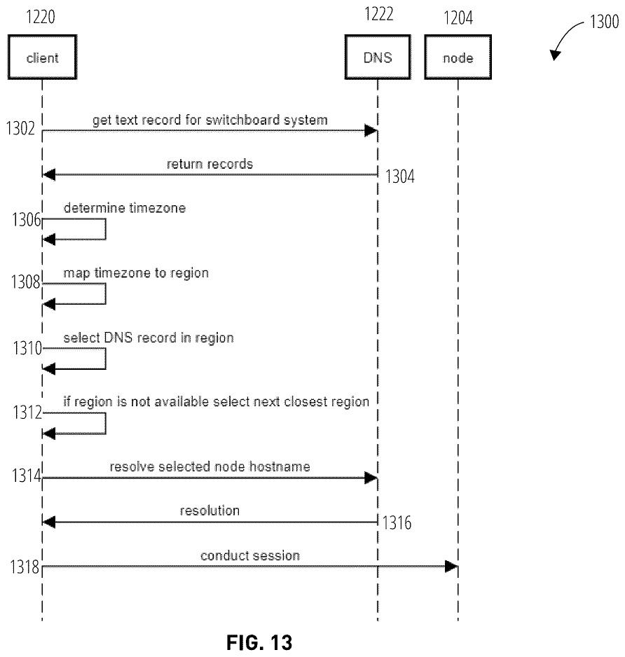

In some embodiments, the nodes 1204 may operate in a cloud-based computing environment, e.g., a collection of hardware, software, and networking components that enable the delivery of cloud computing services. The switchboard nodes 1204 and the computing services are delivered over the Internet and can be accessed from anywhere in the world with an Internet connection. In embodiments, client 1220 may access a switchboard node 1204 through Domain Name System 1222 or Domain Name System (DNS). The DNS 1222 is a hierarchical and distributed naming system for computers, services, and other resources connected to the Internet or other networks. It associates various information with domain names assigned to each registered participant. In one example, the DNS 1222 may translate a name known to software executing on a client 1220 to route data to one or more of switchboard node 1204 of the switchboard system. In embodiments, the DNS 1222 may generate a number, such as an Internet Protocol (IP) address, an address record (A-record), or another Hostname (C-name record). FIG. 13 illustrates one example sequence 1300 for a client to identify and resolve an identifier for one of the nodes 1204 of the switchboard system. At a high level, the Domain Name System 1222 translates known domain names to numerical Internet Protocol (IP) addresses needed for locating and identifying computer services and devices with the underlying network protocols. Clients use the global DNS system to select the best node to use, as discussed in sequence 1300.

In embodiments, a client 1220 communicates with the switchboard system 1200 to perform one or more of the partner services 1224, such as conducting a transaction with a merchant, validating the customer, or other tap-to functions. Once client 1220 identifies a switchboard node 1204 and resolves an address to communicate with switchboard node 1204, client 1220 may send one or more messages to switchboard node 1204 to authenticate and perform the operation. The switchboard node 1204 includes an authentication 1210 function that is configured to authenticate the client 1220. In embodiments, the client 1220 sends a message or authorization request to the switchboard node 1204 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 3 describes the value, name, and meaning:

TABLE 3

| Value | Name | Meaning |
|---|---|---|
| 65535 | Client | Individual |
| | ID | identifier |
| | | of client |
| GReyx5BuEAaE72bWbFZJfHRL8Dbt1Uum | Client | Randomly |
| | Key | assigned key |

The switchboard node 1204 may authorize or authenticate the client 1220 or user, and the switchboard node 1204 may utilize the additional components, such as the session and nonce session and node generator 1206 and message router 1208, to perform the operations. Note the validators 1218 never interact with the merchant systems 1216, nor vice versa. The nodes 1204 brokers all communication.

In embodiments, the switchboard system 1200 may utilize a hyper ledger fabric 1226 to manage to synchronize the shared operation data 1212 and member management across the network. The hyperledger fabric 1226 is distributed ledger framework having a permissioned network model that only authorized participants can join the network and access the data that is stored on a ledger.

In embodiments, the hyperledger fabric 1226 may be generated by creating one or more sets of peers, an ordering service, and a channel. Once the network is created, system 1200 deploys chaincode to the network, or node 1204 is permitted to access the fabric. The chaincode is the code that runs on the blockchain and executes the network control 1228 and operation data 1212 logic code. Once the chaincode is deployed, each of the switchboard nodes 1204 is configured to invoke transactions on the blockchain to add data to the blockchain, e.g., the operational data. A switchboard node 1204 or another device can query the ledger to retrieve data. The ledger is a distributed database that stores all the data added to the blockchain.

All nodes 1204 keep an independently verifiable log of their actions that can be transmitted to a centralized aggregator to build a picture of overall network usage. System 1200 can manage network operation data and management at a central level and have a centralized view of network use, aggregated and abstracted to the appropriate level.

FIG. 13 illustrates an example sequence 1300 for a client to utilize DNS to resolve and communicate with one or more nodes of a switchboard system 1200. The illustrated sequence 1300 includes a client 1220, a DNS 1222, and a switchboard node 1204. At 1302, the sequence 1302 includes the client 1220 sending a request to a default DNS server for a text record switchboard. {domain}. {tld}. The text record may be preconfigured in a client app and/or client sdk. At 1304, the DNS 1222 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 1204

In embodiments, the client 1220 may determine the current timezone at 1306. For example, the client app or sdk may utilize a get current timezone function, such as in JavaScript: Intl.DateTimeFormat( ).resolvedOptions( ).timeZone). Embodiments are not limited in this manner, and the app or sdk may determine the timezone via another/different function call. At 1308, the client 1220 is configured to map the timezone to a region or short-version identifier of the region. One example includes America/New_York->na-e. The region may be based on DNS names, for example. Table 4 illustrates a few examples of timezone mappings to regions:

TABLE 4

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1310, the client may identify or select a DNS record option returned at 1304 that is in the region. If there are multiple matches, the client may select one at random. If there's no node available in a region, the client may determine and use a data graph of neighboring regions to select a node in the closest region where a node is available at 1312. For example, sa has no node but is connected to na-e where there is a node and so na-e is selected.

At 1314, the client may resolve a selected node's hostname. In embodiments, the client 1220 may automatically resolve the hostname using the client's HTTP request default resolver. At 1316, the Domain Name System 1222 may return a result. And at 1318, the client 1220 may communicate with a switchboard node 1204 and begin the process to interact with the switchboard.

FIG. 14A-FIG. 14C illustrate an example sequence 1400 to perform operations between a contactless card and services provided by a card issuer and/or merchant. The illustrated sequence 1400 includes actions and communications performed by a contactless card 106, a client 1220 including a client app 1402 and a client sdk 1404, a DNS 1406, a switchboard system including one or more nodes 1204, a partner services 1224 including a merchant system 1216 and/or validator 1218, and control services 1230 including a client server 1410 or system. In embodiments, the client app 1402 may be any application configured to execute on a client 1220, such as a banking app, a merchant app, a social media app, a travel app, a gaming app, a productivity app, an entertainment app, and so forth. In embodiments, the client app 1402 includes a web browser to provide websites and pages. The client app 1402 may include and/or utilize the client sdk 1404, which may be a set of instructions that enable the client app 1402 to communicate with other components of the switchboard system.

In embodiments, at 1412 the client 1220 including the client app 1402 may send a request and establish a session with a client server 1410 such that a result may be associated with the correct client device or user. The request establishes a relationship between the client device and client server, which may be an issuer server. At 1414, the client server 1410 generates a session and CLIENT SESSION INFORMATION. At 1416, the client server 1410 returns the session information, e.g., the CLIENT SESSION INFORMATION. In embodiments, the CLIENT SESSION INFORMATION may be the Client implementation-specific user session identification information.

At 1418, the client 1220 may initiate a contactless card authentication process with the client 1220. For example, the client 1220 may call a function and/or pass information to the client 1220 to initiate authentication via a contactless card. At 1420-1422, the client 1220 may utilize DNS to identify a node and establish communication with the node. Specifically, at 1420, the client 1220 including the client sdk 1404 may send a request for switchboard hostnames, and at 1424 the DNS 1406 may return information including one or more hostnames. At 1422, the client 1220 may determine a switchboard node to communicate. FIG. 13 illustrates an example of a more detailed sequence of the process to establish communication with a switchboard node.

At 1426, the client 1220 may send a request for a session to the switchboard system 1204. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, etc. At 1418, switchboard system 1204 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 1200 private key. The switchboard system 1200 may include a NODE PUBLIC/PRIVATE KEY, which is a keypair used to sign and validate JWTs.

At 1428, the switchboard system 1200 may return session information to the client 1220. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 922, the client sdk 1404 may determine and/or receive user consent to the terms of service. In one example, the client sdk 1404 captures and records the user consent to <FUNCTION TOS> on <CONSENT DATE> with <TOS VERSION>. The CONSENT DATE may be the timestamp for the user's consent to the TOS.

At 1430, the client 1220 exchanges one or more messages with a contactless card 602. In one example, the exchange may be based on the contactless card 602 being tapped to a client device. In embodiments, the client sdk 1404 may provide data to the contactless card 602 to use during the session to perform the function. The data may be provided to the contactless card 602 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 5 below illustrates an example of an NDEF message format.

| Byte | Data Item | Value |
|---|---|---|
| 00 | NDEF Message | D1 (only record) |
| | Tag | |
| 01 | Length of | 01 |
| | Record Type | |
| 02 | Length of | 33 |
| | Record | |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes binary |
| 0E | | data |
| 0F . . . | Session | 4 bytes of ASCII HEX encoded 2 bytes binary |
| 12 | Indicators | data |
| 13 . . . | Control | 4 bytes of ASCII HEX encoded 2 bytes binary |
| 16 | Indicators | data |
| 17 . . . | Update Date | 16 bytes of ASCII HEX encoded 8 bytes binary |
| 26 | creation Time | data - represents 64 bit unix timestamp |
| 27 . . . | Update MAC | MAC to protect control indicators - 16 bytes |
| 36 | | of ASCII HEX encoded 8 bytes binary data |

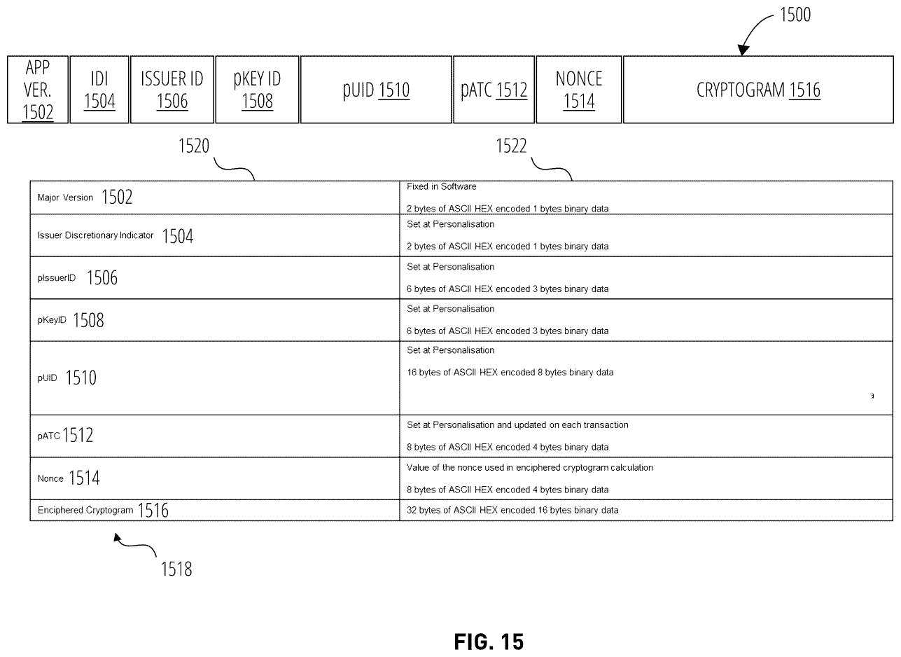

The updated MAC may be calculated to protect the control indicators in embodiments. Specifically, The MAC M is determined by calculating a MAC over the 10 bytes of the update data U with the Update MAC Card Key (MCK), as described in conjunction with FIG. 15.

At 1430, the contactless card may generate and provide a message to the client's device including the client sdk 1220. The data in the message may be utilized by the system discussed herein to perform the function requested. One example of the message is illustrated and discussed in FIG. 15, message 1500.

At 1432, the client 1220 including the client sdk 1404 may send a message and information to the switchboard system 1204. The message may be the message received from the contactless card 106, e.g., message 1500. In addition, the client sdk 1404 may send the consent date, the TOS version, and the signed session token to the switchboard system 1200. The switchboard system 1200 may utilize the information to ensure the session is valid. At 1434, the switchboard system 1200 verifies the signed session token is valid, e.g., is the previously provided signed session token and includes the nonce previously generated and is in the message.

In some embodiments, the switchboard system 1200 is configured to determine which issuer system or client-server it should route the message to for processing. At 1436, the switchboard system 1200 may determine the issuer ID by extracting it from the message received from the contactless card 106 via the client sdk 1404. As mentioned, the issuer ID identifies the issuer of the contactless card 106.

Referring now to FIG. 14B, in some embodiments, the switchboard system 1200 is configured to generate and communicate secure communications with the issuer system, e.g., the client server 1410 and the validator 1218. At 1438, the switchboard system 1408 sends a request for a key to the client server 1410. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1440, the client server 1410 generates a portion of the key. In some instances, the client server 1410 may generate half of the ECDH key for encryption/decryption of PII. Specifically, the client server 1410 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1442, the client server 1410 stores the generated portion of the key in storage. Specifically, the client server 1410 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1410 may return the public key portion to the switchboard system 1408 with the KEY ID at 1444. The switchboard system 1200 may store the public key portion with the KEY ID for later use, e.g., generation of the ECDH key. At 1446, the switchboard system 1200 may request a validation to be performed by the validator 1218. In one example, the switchboard system 1408 may send a request validation as Request validation <MESSAGE>, <SIGNED SESSION TOKEN>, <CLIENT EC PUBLIC KEY>, <CONSENT DATE>, and the <TOS VERSION>. The validator 1218 may make an out-of-band request back to the switchboard network 1202 for the public key to verify the session at 942. At 944, the switchboard network node 1204 may provide the node's public key, i.e., <NODE PUBLIC KEY>. Further at 946, the validator 1218 may utilize the node's public key to verify the secure session token.

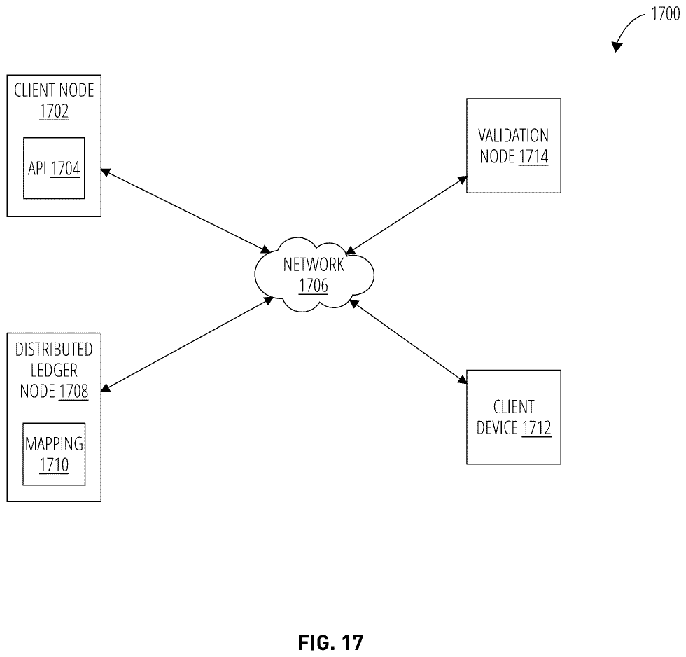

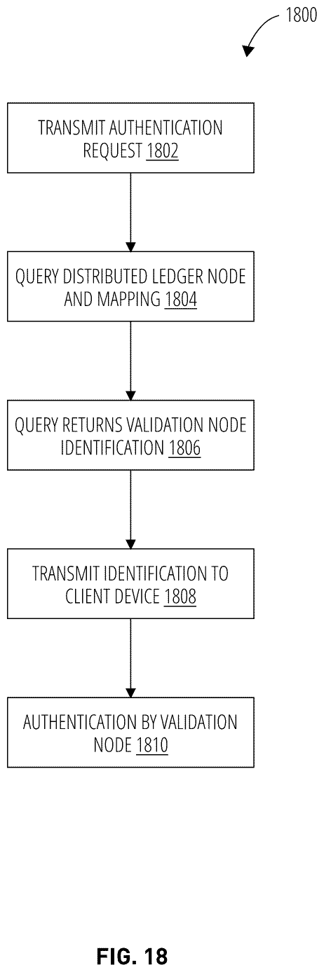

In embodiments, the validator 1218 may validate the message at 1448. In embodiments, the validator 1218 may perform a number of validations including ensuring the nonce in the message is correct along with additional information, such as the card's unique identifier (pUID), and the counter value (pATC). FIG. 17 and FIG. 18 discuss additional details of a validation process that may be performed.

At 1450, the validator 1218 may store information associated with the session. For example, validator 1218 may store the <CONSENT DATE> with the <TOS VERSION> and the <PUID>. The validator 1218 may also generate another portion of the key, e.g., the ECDH key. For example, the 1408 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1452, the validator 1218 may generate the complete ECDH key. For example, the validator 1218 generates the <ECDH KEY> from <ISSUER EC PRIVATE KEY> and <CLIENT EC PUBLIC KEY>. The ECDH KEY is the final key generated using ECDH key negotiation.

The validator 1218 may utilize the ECDH KEY to encrypt data for the function. For example, if the validator 1218 validates the message in some instances, the validator 1218 may execute a function request to create a function result and encrypt the result with the ECDH KEY at 956. For example, the validator 1218 may Execute <FUNCTION REQUEST> to create <FUNCTION RESULT> and encrypt it with the <ECDH KEY>. The function result may be any result based on the requested function, e.g., verification of the card, access customer data in a record associated with a contactless card of an account database, and/or the like.

At 1454, the validator 1218 may return the function result to the switchboard system 1200. In some instances, the function result is returned encrypted. For example, the validator 1218 may return the <ENCRYPTED FUNCTION RESULT> and the <ISSUER EC PUBLIC KEY>.

Referring now to FIG. 14C, in some embodiments, the switchboard system 1200 sends the function result at 1456 to the client server 1410 to process the result. In one example, the switchboard system 1200 may send the <ENCRYPTED FUNCTION RESULT>, <KEY ID>, <ISSUER EC PUBLIC KEY>, and <SIGNED SESSION TOKEN>. At 1458 and 1460, the client server 1410 may make a request for and receive the public key from the switchboard system 1200. In some instances, the exchange may be performed via out-of-band communication channels. The public key for the node may be <NODE PUBLIC KEY>. The public key may be used to verify the sender of the function result, etc. At 1462, the client server 1410 may verify the signed session key with the node's public key <NODE PUBLIC KEY> to verify the sender of the information. At 1464, the client server 1410 may extract client information from the signed session token. For example, the client server 1410 may Extract <CLIENT SESSION INFO> from <SIGNED SESSION TOKEN>, i.e., extracting the client implementation-specific user session identification information.

Further, at 1466, the client server 1410 may retrieve the client's private key with the KEY ID. Specifically, the client server 1410 may get and remove the <CLIENT PRIVATE KEY> from cache using the <KEY ID>. At 1468, the client server 1410 may generate or compute the ECDH key. For example, the client server 1410 may compute the <ECDH KEY> with the <CLIENT PRIVATE KEY>+<ISSUER EC PUBLIC KEY>. The client server 1410 may decrypt the function result with the computed key at 1470. Specifically, the client server 1410 may decrypt the <ENCRYPTED FUNCTION RESULT> with the <ECDH KEY> to determine the <FUNCTION RESULT>. At 1472, the client server 1410 associates the function result with the session.

In embodiments, the switchboard system 1200 may return whether the function result was successfully completed or not at 1474 to the client sdk 1404. Further at 1476, the client sdk 1404 may notify the client app 1402 of the result. At 1478, the client app 1402 may utilize the feature. For example, the 1478 may communicate with the client server 1410 to continue the feature using the <CLIENT SESSION INFO> to fetch the redacted <FUNCTION RESULT>.

FIG. 15 illustrates an example of a message 1500 that may be communicated by a contactless card to perform the functions described herein, such as those discussed in FIG. 14A through FIG. 14C. One or more of the fields in message 1500 may also be utilized to route the message 1500 through the switchboard system and perform authentication/validation techniques.

In embodiments, the message 1500 includes an applet version 1502 field, an issuer discretionary indicator 1504 field, an Issuer Identifier 1506 field, a pKey ID 1508 field, a pUID 1510 field, a pATC 1512 field, a nonce 1514 field, and an encrypted cryptogram 1516.

In embodiments, the fields may be in plain text or encrypted. For example, the applet version 1502 field may include an applet version in plain text. The applet version indicates which applet version is installed on a contactless card and may be used by the other systems to determine how to process the message 1500 when communicated. For example, different Applet versions require different validation logic, e.g., an older message may be routed through the issuer system to perform various operations for validation, while a newer message may be routed through the switchboard system 1200 to perform the various operations, including validation.

In embodiments, the message 1500 includes an issuer discretionary indicator 1504 field that may include issuer data and set at the time of personalization. In addition, the message 1500 includes an Issuer Identifier 1506 field that may include a unique ID assigned to the entity issuing the card, e.g., the issuer. For example, when joining the system 1200, each issuer may be assigned a unique identifier during an onboarding operation. The issuer ID can be used by the switchboard system 1200 to route a message and its contents to the appropriate services that are associated with that particular issuer.

In embodiments, the message 1500 includes a pKey ID 1508 field. In some instances, the pKey ID 1508 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system 1200 to perform a validation.

In embodiments, each contactless card 602 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described in conjunction with FIG. 15.

The message 1500 may include a pUID 1510 field, including a card unique identifier assigned to the contactless card at personalization time. The pUID 1510 field data may be a combination of alphanumeric characters used to identify each card and associated with a user uniquely.

In embodiments, the message 1500 includes a pATC 1512 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1500 is created, a new session key is derived and utilized to generate one or more portions of the message 1500. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1500 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 602 may communicate a message between a device, such as a mobile device, during a read operation. For example, in response to the contactless card 602 being tapped onto a surface of the device, e.g., brought within wireless communication range, a read operation may be performed on the contactless card 602, and the contactless card 602 may generate and provide the message to the device. For example, once within range, the contactless card 602 and the device may perform one or more exchanges for the contactless card 602 to send the message to the device.

The wireless communication may be in accordance with a wireless protocol, such as near-field communication (NFC), Bluetooth, WiFi, and the like. In some instances, a message may be communicated between a contactless card 602 and a device via wired means, e.g., via the contact pad, and in accordance with the EMV protocol.

As discussed above, the contactless card 602 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 602. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card 602 may have one or more UDKs.

In embodiments, each contactless card 602 includes one or more applications, such as an authentication application, that is given a unique 16-digit identity (pUID) at time of personalization. Each contactless card 602 may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc., may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card stores the generated application key(s) or UDK(s).

In embodiments, the contactless card 602 utilizes the application key(s) or UDK(s) to generate session keys for each encrypted data is generated. The following is one processing flow that may be performed by the contactless to generate a unique cryptogram session key (ASK).

To generate the ASK, the contactless card 602 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 602 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 602 concatenates SKL with SKR to form an authentication session key (ASK). In embodiments, the ASK is used to perform operations utilizing the contactless card 602, such as encrypting the cryptographic MAC.

In embodiments, the contactless card 602 also supports session key derivation to generate a unique encipherment session key DESK. The contactless card computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card computes SKR by encrypting [ATC[2]∥ATC[3]∥‘0F’∥‘00’∥‘00’∥‘00’∥‘00’∥‘00’] with the DEK or UDK. The contactless card 602 concatenates SKL with SKR to form the Data Encipherment Session Key (DESK).

In embodiments, the contactless card 602 generates encrypted data or a cryptogram utilizing the session keys. Specifically, the contactless card 602 generates a cryptogram C by calculating a MAC over the 32-byte transaction data T using the Authentication Session Key (ASK).

The contactless card 602 may process the data to generate the cryptogram. Specifically, the contactless card 602 divides T into four blocks of 8 bytes of data: T=T1∥T2∥T3∥T4. The contactless card computes B=DES(ASKL) [T1], where is the Data Encryption Standard or another symmetric encryption algorithm, ASKL is a portion of the ASK, e.g., the “left” half of the key. The contactless card 602 computes B=[B XOR T2], and, the contactless card 602 computes B=DES(ASKL) [B], where DES is an encryption algorithm. The contactless card 602 computes B=[B XOR T3], and the contactless card 602 computes B=DES(ASKL) [B]. The contactless card 602 computes B=[B XOR T4], and the contactless card computes B=DES(ASKL) [B]. The contactless card 602 computes B=DES⁻¹(ASKR) [B], where DES⁻¹ is the reciprocal DES operation, and ASKR is a portion of the ASK, e.g., the right half. The contactless card 602 computes the cryptogram C=DES(ASKL) [B].

In embodiments, a contactless card 602 may also encipher the cryptogram to secure the data further. For example, a contactless card 602 may generate an 8-byte random number [RND] and the card computes E1=DES3(DESK) [RND], where DES3 is a symmetric encryption algorithm such as the Triple Data Encryption Standard. The contactless card then computes B=[E1] XOR [C], where C is the cryptogram generated, as discussed above. The contactless card 602 computes E2=DES3(DESK) [B], where B is computed above. Further, the contactless card 602 generates the 16-byte enciphered payload E=[E1][E2].

In embodiments, a device or the contactless card 602 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 602 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes) Update Date Time (8 bytes) ∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

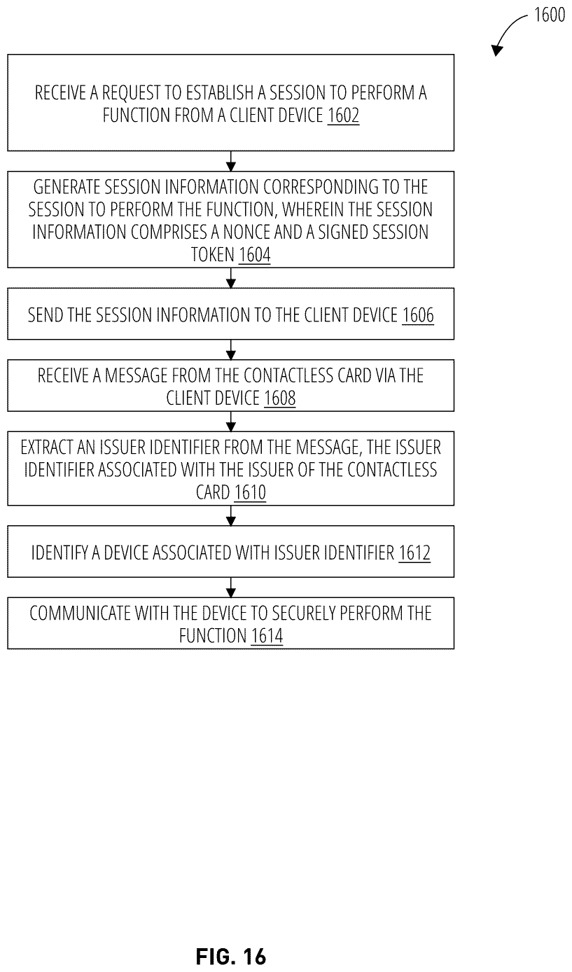

FIG. 16 illustrates an example of routine 1600 in accordance with embodiments discussed herein. In block 1602, the routine 1600 includes receiving, by a node in a system, a request to establish a session to perform a function from a client device, wherein the function is at least partially performed utilizing a contactless card 602. In some instances, the node may be one of a plurality nodes of a switchboard system. The node may be previously selected by the sending device via a DNS operation performed.

In block 1604, the routine 1600 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card 602 is authenticated, and to keep track of the session for the function.

In block 1606, routine 1600 includes sending the session information to the client device by the node. The client device may communicate with a contactless card 602 to receive data from the card to authenticate and perform a function. In some instances, the client device may send the nonce from the node to the contactless card 602. The contactless card 602 may utilize the nonce when generating the message to communicate back to the client device. Finally, the node, e.g., incorporates it into a cryptographic portion of the message (see FIG. 15).

In block 1608, routine 1600 includes receiving, by the node, a message from the contactless card via the client device. The message may be generated by the contactless card 602. FIG. 15 illustrates one example of a message 1500. In some embodiments, the node verifies the message. For example, the node may verify a nonce in the message and a signed session token.

In block 1610, routine 1600 extracts an issuer identifier from the message by the node, the issuer identifier associated with the issuer of the contactless card 602. In some instances, the issuer identifier may be in a plaintext format.

In block 1612, routine 1600 identifies, by the node, a device associated with the issuer identifier. For example, the node may perform a lookup to determine a server associated with the issuer identifier and the function to be performed.

In block 1614, routine 1600 communicates, by the node, with the device to securely perform the function.

FIG. 17 illustrates a distributed network authentication system 1700 according to an example embodiment. As further discussed below, system 1700 can include client node 1702, API 1704, network 1706, distributed ledger node 1708, mapping 1710, and client device 1712. Although FIG. 17 illustrates single instances of the components, system 1700 can include any number of components.

System 1700 can include a client node 1702, which can be a network-enabled computer as described herein. In some examples, client node 1702 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1700.

In some examples, client node 1702 can execute one or more applications, such as software applications, that enable, for example, network communications with one or more components of system 1100, transmit and/or receive data, and perform the functions and processes described herein.

The client node 1702 can contain an API 1704. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1704 to interact with the service, such as by performing a remote call to an API for interacting with a web-based service.

API 1704 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1702 can communicate with one or more other components of system 1700 either directly or via network 1706. Network 1706 can comprise one or more of a wireless network, a wired network or any combination of wireless network and wired network, and may be configured to connect the components of system 1700. While FIG. 17 illustrates communication between the components of system 1700 through network 1706, it is understood that any component of system 1100 can communicate directly with another component of system 1700, e.g., without involving network 1706.

System 1700 can include a validation node 1714, which can be a network-enabled computer as described herein. In some examples, validation node 1714 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1700.

In some examples, validation node 1714 can execute one or more applications, such as software applications, that enable, for example, network communications with one or more components of system 1700, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1700 can include a distributed ledger node 1708, which can be a network-enabled computer as described herein. In some examples, distributed ledger node 1708 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1700.

In some examples, distributed ledger node 1708 can execute one or more applications, such as software applications, that enable, for example, network communications with one or more components of system 1700, transmit and/or receive data, and perform the functions and processes described herein.

Distributed ledger node 1708 can containing a mapping 1710. In some examples, mapping 1710 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1700, or the one or more databases can be hosted externally to any component of the system 1700. In some examples, the one or more databases can be contained in the distributed ledger node 1708, and in other examples the one or more databases can be stored outside of distributed edger node 1708 but in data communication with distributed ledger node 1708. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1708. In other examples, the one or more databases can be remote from distributed ledger node 1708 but in data communication with distributed ledger node 1708. Data communication between the one or more databases and distributed ledger node 1708 can be a direct data communication or data communication via a network, such as the network 1706.

In some examples, client node 1702 can be in data communication with distributed ledger node 1708. Distributed ledger node 1708 can contain mapping 1710. Mapping 1710 may include, e.g., a mapping between a validation node address and the validation node 1714, a mapping between a routing number and a validation node address, and/or a mapping between a routing number and validation node 1714. In some examples, mapping 1710 can include a digital signature associated with an entity having permission to validate for a routing number. Based on one or more of these associations, client node 1702 can call validation node for validation and/or provide direction to the client device to reach the appropriate validation node. This can be accomplished by calling a validation API associated with validation node 1714.

In some examples, iterations of the mappings described herein, such as mapping 1710, can also include a software or applet version number. The version number can be used to identify a validation node or validation node address or choose between multiple validation addresses for one validation node.

In some examples, client node 1702 and distributed ledger node 1708 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1708 can update mapping 1710 to reflect a different association between, e.g., a routing number, a validation node address, and a validation node. In some examples, degrees of permissions can be issued. For example, if client node 1702 were to function to route data to validation node 1714 (or other validation nodes), client node 1702 can be given a certain level of permissions. As another example, if distributed ledger node 1708 were to have the capability to update mapping 1710, distributed ledger node 1708 can have a different, higher level of permissions.

System 1100 can include a client device 1712, which can be a network-enabled computer as described herein. In some examples, distributed ledger node 1708 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 1712 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1712 can be in data communication with another network-enabled computer not shown in FIG. 17, such as a smart card (e.g., a contactless card or a contact-based card).

In some examples, client device 1712 can execute one or more applications, such as software applications, that enable, for example, network communications with one or more components of system 1700, transmit and/or receive data, and perform the functions and processes described herein.

In some examples, upon receipt of an authentication request, client device 1712 can call (e.g., via an API) client node 1702. The call can include a routing number and/or an applet or software version number, and client node 1702 can query distributed ledger node 1708 and mapping 1710. Once the query returns the identification of a validation node (e.g., validation node 1714) and/or a validation node address associated with that routing number and/or applet or software version, client node 1702 can reply to client device 1712. Client device 1712 can then proceed with authentication with the validation node. The authentication can be performed by, e.g., the systems and methods described herein, such as by the generation, encryption, transmission, decryption, and validation of a cryptogram as described herein.

In some examples, client node 1702 can be co-resident with validation node 1714. In these examples, client node 1702 can handle the authentication in a single call from client device 1712. In some examples, this can be acceptable only if it is permissible for the full authentication transmission (e.g., a cryptogram as described herein) to be sent to client nodes 1702 that are not involved in authentication.

In some examples, if client node 1702 receives, from client device 1712, a routing number that is not handled by its location, client node 1702 can return a code indicating that this routing number is not handled, along with validation node address for the responsible validation node. Client device 1712 can then send the full authentication transmission to validation node 1714 using the received validation node address.

In some examples, client node 1702 can enter the distributed network with different permissions. For example, client node 1702 can be a read-only router of data. As another example, client node 1702 can have permission to send messages to distributed ledger node 1708 updating one or more routing paths for one or more routing numbers. However, client node 1702 would be prevented from updating one or more routing paths for one or more routing numbers for other entities that control other routing numbers which are not associated with client node 1702 or that did not grant this permission. As another example, distributed ledger node 1708 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1702, distributed ledger node 1708, and/or validation node 1714, if security, legal, and/or financial conditions are met, however, delegation is not required.

In some examples, one or more APIs can facilitate communication between components of system 1100 via network 1706. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1714 for authentication, can require storage of the keys in one or more HSMs, to promote key security and ensure that the keys are never entered into memory.

FIG. 18 illustrates a method 1800 performed by a distributed network authentication system according to an example embodiment. For example, the method can be performed by distributed network authentication system 1700 and or by another distributed network authentication system.

In block 1802, a client device 1712 can transmit an authentication request to a client node 1702. The authentication request can include, without limitation, a routing number, a software version number, and/or an applet version number. The request can be made by an API call or other communication between the client device 1712 and the client node 1702.

In block 1804, after receiving the authentication request, the client node 1702 can transmit a query (e.g., via an API call) to a distributed ledger node. The distributed ledger node 1708 contain a mapping, and the distributed ledger node can submit the query to the mapping.

In block 1806, the query can return an identification of a validation node and/or a validation node address, and the distributed ledger node can transmit this identification to the client node 1702.

In block 1808, the client node 1702 can transmit the identification to the client device 1712. After receiving the identification, the client device 1712 can proceed with authentication with the identified validation node and/or validation node address, in block 1810.

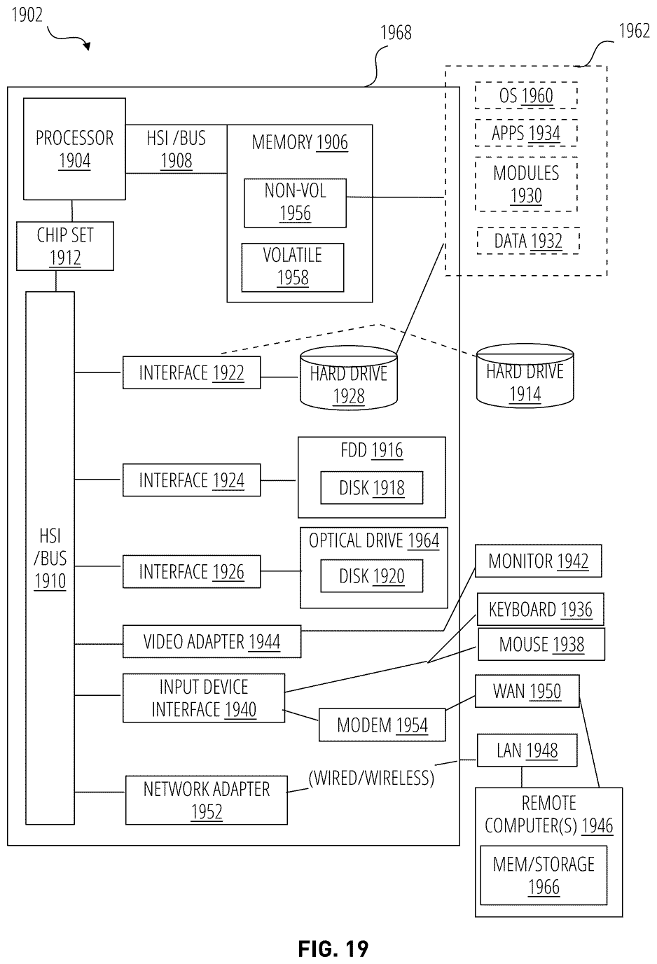

FIG. 19 illustrates an embodiment of an exemplary computer architecture 1902 suitable for implementing various embodiments as previously described. In one embodiment, the computer architecture may include or be implemented as part of computer architecture 1902. For example, the computer architecture 1470 or parts of it can be used to implement the client device 604, the contactless card 602, the server 608, and the switchboard network node 1204. In some cases, for example, in the case of the contactless card 602, some of the components described herein may not be included.

As used in this application, the terms “system” and “component” are intended to refer to a computer-related entity, either hardware, a combination of hardware and software, software, or software in execution, examples of which are provided by the exemplary computer architecture 1902 1470. For example, a component can be, but is not limited to being, a process running on a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1902 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 1902.

As shown in FIG. 19, the computer architecture 1902 includes a computer 1968 comprising a processor 1904, a system memory 1906, a high-speed interconnect/bus (HSI/bus) 1908, and an HSI/bus 1910. The processor 1904 can be any of various commercially available processors. The computer 1968 may be representative of the client device 604 and/or the server 608.

The HSI/bus 1908 provides an interface for system components including, but not limited to, the system memory 1906 to the processor 1904. The HSI/bus 1908 can be any of several types of bus structure or interconnect structure that may interconnect to a memory 1906. For instance, the HSI/bus 1908 may comprise a high-speed serial interconnect to interconnect the processor 1904 with a memory 1906 dedicated for that processor 1904. In other embodiments, the HSI/bus 1908 may comprise a bus with arbitration to interconnect multiple processors with the memory 1906.

The HSI/bus 1910 provides an interface for system components including, but not limited to, a chip set 1912. The HSI/bus 1908 can be any of several types of bus structure or interconnect structures that may interconnect to a chip set 1912, a peripheral bus, and a local bus using any of a variety of commercially available bus or interconnect architectures. The chip set 1912 may comprise a set of one or more chips that operate in conjunction with the processor 1904 to interconnect peripheral devices with the processor 1904.

Interface adapters may connect to the HSI/bus 1910 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1902 may include or implement various articles of manufacture. An article of manufacture may include a computer-readable storage medium to store logic. Examples of a computer-readable storage medium may include any tangible media capable of storing electronic data, including volatile memory 1958 or non-volatile memory 1956, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 19, the system memory 1906 can include non-volatile memory 1956 and/or volatile memory 1958. A basic input/output system (BIOS) can be stored in the non-volatile memory 1956.

The computer 1968 may include various types of computer-readable storage media in the form of one or more lower speed memory units, including an internal (or external) hard disk drive hard drive 1914, a magnetic disk drive such as floppy disk drive (FDD) 1916 to read from or write to a removable magnetic disk 1918, and an optical disk drive 1648 to read from or write to a removable optical disk 1920 (e.g., a CD-ROM or DVD). The hard disk drive 1438, magnetic disk drive 1916 and optical disk drive 1648 can be connected to the HSI/bus 1910 by an HDD interface 1922, and FDD interface 1924 and an optical disk drive interface 1926, respectively. The HDD interface 1922 for external drive hard drive 1914 implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules 1962 can be stored in the drives hard drive 1928, hard drive 1914, non-volatile memory 1956, and/or volatile memory 1958, including an operating system (OS) 1960, one or more applications (apps) 1934, other program modules 1930, and program data 1932. In one embodiment, the one or more applications 1934, other program modules 1930, and program data 1932 can include, for example, the various applications and/or components of the computer architecture 1902.

A user can enter commands and information into the computer 1968 through one or more wire/wireless input devices, for example, a keyboard 1936 and a pointing device, such as a mouse 1938. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1904 through an input device interface 1940 that is coupled to the HSI/bus 1910 but can be connected by other interfaces such as a parallel port, IEEE 1394 serial port, a game port, a USB port, an IR interface, and so forth.

A monitor 1942 or other type of display device is also connected to the HSI/bus 1910 via an interface, such as a video adapter 1944. The monitor 1942 may be internal or external to the computer 1968. In addition to the monitor 1942, a computer typically includes other peripheral output devices, such as speakers, printers, and so forth.

The computer 1968 may operate in a networked environment using logical connections via wire and/or wireless communications to one or more remote computers, such as a remote computer(s) 1946. The remote computer(s) 1946 can be a workstation, a server computer, a router, a personal computer, portable computer, microprocessor-based entertainment appliance, a peer device or other common network node, and typically includes many or all the elements described relative to the computer 1466, although, for purposes of brevity, only a memory and/or storage device 1464 is illustrated. The logical connections depicted include wire/wireless connectivity to a local area network (LAN) 1948 and/or larger networks, for example, a wide area network (WAN) 1458. Such LAN 1948 and WAN1950 networking environments are commonplace in offices and companies, and facilitate enterprise-wide computer networks, such as intranets, all of which may connect to a global communications network, for example, the Internet.

When used in a LAN 1948 networking environment, the computer 1968 is connected to the LAN 1948 through a wire and/or wireless communication network interface or network adapter 1952. The network adapter 1952 can facilitate wire and/or wireless communications to the LAN 1948, which may also include a wireless access point disposed thereon for communicating with the wireless functionality of the network adapter 1952.

When used in a WAN 1950 networking environment, the computer 1968 can include a modem 1954, or is connected to a communications server on the wan 1950 or has other means for establishing communications over the wan 1950, such as by way of the Internet. The modem 1954, which can be internal or external and a wire and/or wireless device, connects to the HSI/bus 1910 via the input device interface 1940. In a networked environment, program modules depicted relative to the computer 1968, or portions thereof, can be stored in the remote memory and/or storage device 1464. It will be appreciated that the network connections shown are exemplary and other means of establishing a communications link between the computers can be used.

The computer 1968 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi, WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ah, ax, ay, ba, be, bh, etc.) to provide secure, reliable, fast wireless connectivity. A Wi-Fi network can be used to connect computers to each other, to the Internet, and to wire networks (which use IEEE 1302.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method, comprising:
receiving, by a server, a request from a computing device via a switchboard network, the request comprising a secure session token received from a node of the switchboard network session and a message from a contactless card;
verifying, by the server, a secure session to transfer customer data to a merchant server via the switchboard network based on the secure session token;
validating the contactless card based on the message;
after validating the message, accessing, based on a function request associated with the secure session, a record associated with the contactless card in an account database to obtain the customer data; and
sending, based on the function request, the customer data to the merchant server via the switchboard network.

2. The method of claim 1, further comprising, generating an issuer key pair, generating a final key based on an issuer private key of the issuer key pair and a client public key, wherein the request further comprises the client public key, and encrypting the customer data with the final key.

3. The method of claim 2, further comprising sending an out-of-band request to the switchboard network node to obtain a node public key.

4. The method of claim 2, further comprising, sending an issuer public key of the issuer key pair to the switchboard network.

5. The method of claim 1, wherein the request further comprises a client public key and a consent date for a terms of service version, wherein the method further comprises validating the session via the consent date for the terms of service version, generating a final key based on the client public key, and encrypting the customer data via the final key.

6. The method of claim 5, further comprising storing information associated with the session, wherein the information comprises the consent date associated with the terms of service version and a unique identifier associated with the contactless card.

7. The method of claim 1, wherein the customer data comprises an email address, a phone number, a physical address, information about preferences associated with a customer profile associated with the contactless card, or a combination thereof.

8. The method of claim 1, wherein the customer data comprises a summary of transaction data associated with the contactless card.

9. A computing apparatus comprising:
a processor; and
a memory storing instructions that, when executed by the processor, configure the processor to:
receive a request from a computing device via a switchboard network, the request comprising a secure session token received from a node of the switchboard network and a message from a contactless card;
verify a secure session to transfer customer data to a merchant server via the switchboard network based on the secure session token with a node key associated with the switchboard network node;
after verifying the secure session token, validate the contactless card based on the message;
access, based on the indication of a function request associated with the secure session, a record associated with the contactless card in an account database to obtain the customer data; and
transmit, based on the function request, the customer data to the merchant server via the switchboard network node, the customer data.

10. The computing apparatus of claim 9, wherein the instructions, when executed by the processor, further configure the processor to generate an issuer key pair, generating a final key based on an issuer private key of the issuer key pair and a client public key, wherein the request further comprises the client public key, and encrypting the customer data with the final key.

11. The computing apparatus of claim 10, wherein generation of the final key comprises generation of the final key based on an elliptical curve.

12. The computing apparatus of claim 10, wherein the instructions, when executed by the processor, further configure the processor to send an issuer public key of the issuer key pair to the switchboard network node.

13. The computing apparatus of claim 9, wherein the customer data comprises an email address, a phone number, a physical address, information about preferences associated with a customer profile associated with the contactless card, or a combination thereof.

14. The computing apparatus of claim 9, wherein the customer data comprises a summary of transaction data associated with the contactless card.

15. A system comprising:
a processor; and
a memory storing instructions that, when executed by the processor, configure the processor to:
receive, from a client device, a session request to establish a switchboard session, wherein the session request comprises a function request to obtain customer data after the contactless card is validated;
send, to the client device, session information, wherein the session information comprises a secure session token;
receive, from the client device, a first request of the switchboard session comprising a message from the contactless card and the secure session token;
verify the switchboard session is valid based on the secure session token;
extract, from the message, an identifier for a bank server associated with the contactless card;
send, to the bank server, a validation request to validate the contactless card and perform the function request for the customer data based on the message, wherein the third request comprises the message and the secure session token;
receive the customer data from the bank server; and
send the customer data to the merchant server.

16. The system of claim 15, the instructions to further cause the processor to send a key request for a merchant server key to the merchant server and receive, in response to the key request for the merchant server key, the merchant server key.

17. The system of claim 16, wherein sending the node public key comprises sending the node public key via an out-of-band communication.

18. The system of claim 15, the instructions to further cause the processor to receive an issuer public key from the bank server, wherein the customer data is encrypted with a final key derived via the issuer public key.

19. The system of claim 15, wherein the customer data comprises an email address, a phone number, a physical address, information about preferences associated with a customer profile associated with the contactless card, or a combination thereof.

20. The system of claim 15, wherein the customer data comprises a summary of transaction data associated with the contactless card.
